(19) United States
(12) Patent Application Publication
(10) Pub. No.: US 2025/0376545 A1
(43) Pub. Date: Dec. 11, 2025

(54) OLEFIN FREE RADICAL POLYMERIZATION METHOD AND OLEFIN FREE RADICAL POLYMERIZATION APPARATUS

(71) Applicants: CHINA PETROLEUM & CHEMICAL CORPORATION, Beijing (CN); ZHEJIANG UNIVERSITY, Hangzhou, Zhejiang (CN); SINOPEC NINGBO NEW MATERIAL RESEARCH INSTITUTE CO., LTD, Ningbo, Zhejiang (CN); ZHENHAI REFINING AND CHEMICAL BRANCH OF SINOPEC, Ningbo, Zhejiang (CN)

(72) Inventors: Jingdai WANG, Hangzhou, Zhejiang (CN); Huajie LIN, Ningbo, Zhejiang (CN); Xiaoqiang FAN, Hangzhou, Zhejiang (CN); Zhanchun SHI, Ningbo, Zhejiang (CN); Yao YANG, Hangzhou, Zhejiang (CN); Guoqiang LIU, Ningbo, Zhejiang (CN); Congjing REN, Hangzhou, Zhejiang (CN); Baozheng TIAN, Ningbo, Zhejiang (CN); Yongrong YANG, Hangzhou, Zhejiang (CN); Zhaokun LIU, Ningbo, Zhejiang (CN)

(21) Appl. No.: 18/876,583

(22) PCT Filed: Aug. 30, 2023
(86) PCT No.: PCT/CN2023/115693

§ 371 Date: Dec. 18, 2024

(30) Foreign Application Priority Data
Jul. 1, 2022 (CN) 202210774665.2
Jul. 1, 2022 (CN) 202210775378.3

(51) Int. Cl. C08F 2/01; C08F 2/38; C08F 110/02

(52) U.S. Cl. CPC C08F 2/01; C08F 2/38; C08F 110/02

(57) ABSTRACT

A method for olefin polymerization includes the steps of: introducing at least two reaction monomer streams containing olefin sources into at least two parallel tubular reactors respectively, performing one-stage high-pressure polymerization respectively, and then introducing the obtained one-stage high-pressure polymerization product into one or more serial tubular reactors to perform multi-stage high-pressure polymerization. At least one free radical polymerization initiator is introduced respectively to participate in one-stage high-pressure polymerization and/or multi-stage high-pressure polymerization, and the pressure of the reaction monomer stream is greater than or equal to 100 MPa. The reaction monomer stream containing olefin source is introduced into at least two parallel tubular reactors, and performs one-stage high-pressure polymerization respectively to better control the feed temperature, pressure and other parameters of the tubular reactor.

### CROSS REFERENCE TO RELATED APPLICATIONS

This application claims the rights and interests of Chinese patent applications 202210774665.2 and 202210775378.3 filed on Jul. 1, 2022, the contents of which are incorporated herein by reference.

### TECHNICAL FIELD

The invention relates to the field of high-pressure polymerization of olefins, and in particular to an olefin free radical polymerization method and an olefin free radical polymerization apparatus.

### BACKGROUND TECHNOLOGY

Low-density polyethylene (LDPE) is produced through high-pressure free radical polymerization. Since tubular reactors are easier to scale up during the polymerization process and more economical, tubular technology gradually dominates.

According to the existing high-pressure tubular technology, the reaction materials are compressed to above 200 MPa, enter a preheater and are heated to 170° C., and then enters a tubular reactor to react. The outlet material of the tubular reactor is separated by a high-pressure separator and a low-pressure separator, in which ethylene, telogen, and some oligomer enter the high-circulation loop and the low-circulation loop, while LDPE with a small amount of ethylene dissolved enters the extruder for granulation. However, LDPE polymers produced in high-pressure tubular reactors usually have narrower molecular weight distribution (MWD) and lower long-chain branching (LCB), while different downstream products have different requirements on the MWD and the LCB of polyethylene. For example, medical grade/food grade LDPE resin requires a narrow MWD, while the production of heavy-duty packaging bags, floor heating pipes and other products with excellent mechanical properties requires a wide MWD. Therefore, it will create better economic benefits to achieve the production of products with different molecular chain structures on one apparatus.

At present, the existing method in this field to adjust MWD and LCB of LDPE products is to change the feeding position of the telogen, including the entrance of second-stage compressor, the interstage of second-stage compressor, the exit of second-stage compressor, preheater, reactor, the upstream of inlet of side line of reactor, etc. Injecting telogen into the compression system can lead to premature polymerization and fouling in the compression system, resulting in a decrease in production load. Injecting the telogen into the reactor or the side line of reactor inlet will cause the telogen to mix with the initiator. It can reduce the initiator efficiency, and the mix of the additional telogen stream and the mainstream may create cold spots and reduce heat transfer rate.

Therefore, it is of great significance to research and develop a method for preparing LDPE.

### SUMMARY OF THE INVENTION

The purpose of the present invention is to realize the production of products with different molecular chain structures on one apparatus which is impossible in the existing high-pressure olefin polymerization process, overcome the reducing of initiation efficiency of the initiator which is due to the mixture of telogen and initiator caused by injection of telogen into the reactor or the side line of reactor, overcome the reducing of heat transfer which is due to the cold spots caused by mixture of telogen additional stream and mainstream (for example, the MWD of polyethylene produced by the existing high-pressure tubular method with high-pressure polymerization is narrow and the long branch content is low, and the same apparatus cannot produce thin film polyethylene products with narrower MWD and lower LCB and coating polyethylene products with higher branching degree and wider molecular weight), and provide an olefin free radical polymerization method and an olefin free radical polymerization apparatus.

The first aspect of the present invention provides a method for free radical polymerization of olefins. The method includes: introducing at least two reaction monomer streams containing olefin source into at least two parallel tubular reactors respectively, performing one-stage high-pressure polymerization respectively, and then introducing obtained product of the one-stage high-pressure polymerization product into one or more serial tubular reactors to perform multi-stage high-pressure polymerization; wherein, at least one free radical polymerization initiator is introduced into the one-stage high-pressure polymerization and/or the multi-stage high-pressure polymerization respectively, and the pressure of the reaction monomer stream containing olefin source is greater than or equal to 100 MPa.

Preferably, the method includes: Reaction monomer stream containing ethylene source is introduced into at least two parallel tubular reactors to perform the reaction with initiator; Part of the material from the outlet of at least one of the at least two parallel tubular reactors is recycled back to at least one of the at least two parallel tubular reactors for reaction; The remaining material from the outlet of the at least two parallel tubular reactors is continuously introduced into one or more serial tubular reactors to react with initiator.

The second aspect of the present invention provides a apparatus for the method of the present invention for free radical polymerization of olefins. The apparatus includes:
One-stage high-pressure polymerization unit and multi-stage high-pressure polymerization unit; Among which,
The one-stage high-pressure polymerization unit is connected in series upstream of the multi-stage high-pressure polymerization unit;
The one-stage high-pressure polymerization unit includes at least two parallel tubular reactors for conducting one-stage high-pressure polymerization respectively on at least two reaction monomer streams containing olefin source;
The multi-stage high-pressure polymerization unit includes one or more serial tubular reactors for conducting multi-stage high-pressure polymerization on the product from the one-stage high-pressure polymerization unit;
At least one tubular reactor in the one-stage high-pressure polymerization unit and/or the multi-stage high-pressure polymerization unit is provided with an initiator inlet.

Preferably, the apparatus further includes: a fluid suction and delivery unit, wherein the fluid suction and delivery unit includes one or at least two parallel fluid suction and delivery apparatuses for sucking and delivering at least one reaction monomer stream containing ethylene source and part of the material from the outlet of at least one tubular reactor in the one-stage high-pressure polymerization unit;

The initiator supply unit is used to deliver initiators to the one-stage high-pressure polymerization unit and the multi-stage high-pressure polymerization unit.

Compared with the prior technology, the present invention at least has the following beneficial effects:
(1) The present invention proposes that at least two reaction monomer streams containing olefin source are introduced into at least two parallel tubular reactors respectively, and each performs one-stage high-pressure polymerization respectively. The parallel arrangement can better control feed temperature, pressure and other parameters of the reactor to achieve product control while ensuring the conversion rate;
(2) The present invention proposes that at least two reaction monomer streams containing olefin sources are introduced into at least two parallel tubular reactors respectively, and each performs one-stage high-pressure polymerization respectively, which can better control the concentration distribution in the tubular reactor of the adjusting agent such as the initiator without changing temperature of reaction section of the tubular reactor to realize the adjustment of the molecular chain structure such as number average molecular weight and MWD of the product and produce downstream products that match different fields by the method of the present invention;
(3) The method proposed by the present invention is not only suitable for olefin homopolymerization initiated by free radical polymerization initiators, but also for copolymerization of olefins and other olefinic monomers, which make it possible to produce a variety of olefin homopolymerization and copolymerization products, so the method of the present invention has good apparatus utilization rate, apparatus applicability and economic benefits;
(4) The method of the present invention can improve the utilization efficiency of olefin raw materials, and increase conversion rate and output;
(5) Polyethylene with significantly wider MWD and higher LCB can be produced by the method of the present invention. Film polyethylene products with narrow MWD and low LCB and coating polyethylene products with wide MWD and high LCB produced by the method of the present invention broaden the application fields of tubular method products, for example, it can produce LDPE with MWD, which refers to the width of the molecular weight distribution range of the ethylene product produced by the method of the present invention, ranging from 5-16;
(6) While ensuring ethylene conversion rate and LDPE output, the method of the present invention can also prepare polyethylene products with a wide. This is specifically reflected in the ratio of MWD to ethylene conversion rate of the LDPE prepared by the method of the present invention is between 0.018 and 0.048.

### BRIEF DESCRIPTION OF THE DRAWINGS

FIG. 1 is an olefin free radical polymerization apparatus according to a preferred embodiment of the present invention;

FIG. 2 is an olefin free radical polymerization apparatus according to another preferred embodiment of the present invention;

FIG. 3 is a reaction flow diagram of an ethylene free radical polymerization method according to some embodiments of the present invention;

FIG. 4 is a reaction flow diagram of an ethylene free radical polymerization method according to other embodiments of the present invention.

DESCRIPTION OF THE REFERENCE SIGNS

| | |
|---|---|
| 1. Circulating material | 2. First-stage compressor |
| compressor | |
| 3. Second-stage compressor | 4/4a/4b. Preheater |
| 5a/5b/5c/6a/6b/6c. | 7. High-pressure relief valve |
| Tubular reactor | |
| 8. Cooler | 9. High-pressure separator |
| 10. High-circulation loop | 11. Low-pressure separator |
| 12. Low-circulation loop | |
| 201. Compression unit | 202. Fluid suction and |
| | delivery apparatus |
| 203. Preheating apparatus A | 204. Preheating apparatus B |
| 205a/205b/206a/206b/206c. | 207. Material A |
| Reaction section | |
| 208. Material C | 209. Chain transfer agent |
| 210. Reaction monomer | 211. Reaction monomer |
| stream A containing | stream B containing |
| ethylene source | ethylene source |
| 212. Reaction monomer | 213. Reaction monomer |
| stream C containing | stream D containing |
| ethylene source | ethylene source |
| 214. Reaction monomer | 215. Material B |
| stream E containing | |
| ethylene source | |
| I1/I2/I3/I4/I5. Initiator | |

### DESCRIPTION OF THE PREFERRED EMBODIMENT

The endpoints of ranges and any values disclosed herein are not limited to the precise range or value, but these ranges or values are to be understood to include values approaching such ranges or values. For numerical ranges, the endpoint values of each range, the endpoint values of each range and individual point values, and the individual point values can be combined with each other to obtain one or more new numerical ranges. These numerical ranges shall be deemed to be specifically disclosed herein.

Unless stated otherwise, the directional terms used such as “upstream, downstream” refer to the flow direction of materials in the apparatus.

The first aspect of the present invention provides a method for free radical polymerization of olefins. The method includes: introducing at least two reaction monomer streams containing olefin source into at least two parallel tubular reactors, performing one-stage high-pressure polymerization respectively, and then introducing obtained product of the one-stage high-pressure polymerization product into one or more serial tubular reactors to perform multi-stage high-pressure polymerization; wherein, at least one free radical polymerization initiator is introduced into the one-stage high-pressure polymerization and/or the multi-stage high-pressure polymerization respectively, and the pressure of the reaction monomer stream containing olefin source is greater than or equal to 100 MPa.

Polyolefin products with wider MWD and higher polymer dispersion index (PDI) can be produced by the method of the present invention. The inventor speculates that the one-stage high-pressure polymerization unit including at least two parallel tubular reactors can better control the reaction time at both high and low temperatures during polymerization, thereby increasing the PDI; at the same time, it can better control parameters of the inlet of the tubular reactor, such as temperature and pressure, when using the apparatus of the present invention, so the product can be controlled without increasing the fouling of the apparatus and decreasing the conversion rate of the reaction monomer stream containing the olefin source by setting the feed of free radical polymerization initiator.

In the present invention, one can choose to compress at least one strand of material containing olefin source and/or at least two streams of materials containing olefin source respectively, so that the materials containing olefin source are compressed into reaction monomer stream with a pressure greater than 100 MPa. The temperature of the material containing olefin source is not limited and can be selected according to needs.

In the present invention, there is no limit to the number of strands of the material containing olefin source. Compression is generally performed using a compression unit. The number of strands of the material containing olefin source corresponds to the number of compression units. The number of strands of the material containing olefin source is less than or equal to the number of strands of the reaction monomer stream. When the number of strands of the material containing olefin source is less than the number of strands of the reaction monomer stream, it can be compressed by the compression unit and then divided into the required number of strands of the reaction monomer stream containing olefin source. For example, after a strand of material containing olefin source is compressed to greater than or equal to 100 MPa through a compression unit, it is divided into two streams of reaction monomer streams containing olefin source.

In the present invention, the high-pressure polymerization conditions in the one-stage high-pressure polymerization and the second-stage high-pressure polymerization are that the reaction monomer stream can be polymerized under high pressure. Preferably, the pressure of the reaction monomer stream containing olefin source is 110-400 MPa (such as 110 MPa, 130 MPa, 150 MPa, 170 MPa, 200 MPa, 250 MPa, 300 MPa, 330 MPa, 350 MPa, and any value within the range consisting of any two of the above values); further preferably 170-330 MPa. It should be understood that the pressure of each of the reaction monomer streams containing olefin source may be the same or different.

In the present invention, those skilled in this field can understand that the pressure of the reaction monomer stream containing olefin source is the inlet pressure of the reaction monomer stream containing olefin source entering the one-stage high-pressure polymerization unit, under which one-stage high-pressure polymerization is carried out.

In the present invention, both the one-stage high-pressure polymerization and the multi-stage high-pressure polymerization are carried out in tubular reactor. There will be a pressure drop in the length direction of the tubular reactor. In the present invention, it is called the pressure drop before and after the one-stage high-pressure polymerization and the pressure drop before and after the multi-stage high-pressure polymerization. Preferably, the ratio of the sum of the pressure drop before and after the one-stage high-pressure polymerization and the pressure drop before and after the multi-stage high-pressure polymerization to the pressure drop before and after the one-stage high-pressure polymerization is 3:1-30:1, preferably 6:1-8:1. In the aforementioned embodiment, the biased flow of materials can be reduced. Among them, “biased flow” refers to the deviation between the ratio of material flow rates in different parallel tubular reactors and the ratio of material flow rates calculated according to Bernoulli's equation to avoid the defect of excessive local temperature, which can realize the adjustment of molecular chain structure such as MWD and LCB of product while ensuring the conversion rate.

In the present invention, as long as the one-stage high-pressure polymerization product flows into one or more serial tubular reactors and the purpose of the present invention can be achieved, there is no restriction on the sequence of each one-stage high-pressure polymerization. It can be performed at the same time or not at the same time. In some preferred embodiments, each stage of high pressure polymerization is performed simultaneously. Using the aforementioned preferred embodiments, the molecular chain structure such as MWD and LCB of the product can be adjusted while ensuring the conversion rate.

According to the present invention, preferably, the temperature of each of the reaction monomer streams containing olefin source is 100-200° C. (for example, 100° C., 120° C., 150° C., 170° C., 200° C., and any value within the range consisting of any two of the above values), preferably 150-200° C. And the sum of each reaction monomer streams containing the olefin source at the inlet of each parallel tubular reactor each satisfies the correlation expression: 10000≥ρ₁/μ₁≥1500, preferably 6000≥ρ₁/μ₁≥3000; the unit of density ρ₁ is: kg/m³, and the unit of viscosity μ₁ is: centipoise (cP). Viscosity is measured at 25° C. Using the aforementioned preferred embodiment, not only can the reaction monomer stream containing olefin source be heated to a temperature that can initiate polymerization, but also adjustment of molecular chain structure of product such as MWD and LCB can be better realized by controlling conditions such as preheating.

In the present invention, the temperature of the one-stage high-pressure polymerization and each multi-stage high-pressure polymerization can be selected as needed. In some preferred embodiments, the temperature of each one-stage high-pressure polymerization and each multi-stage high-pressure polymerization is 100-350° C. (such as 100° C., 120° C., 125° C., 135° C., 150° C., 164° C., 170° C., 176° C., 180° C., 190° C., 192° C., 203° C., 211° C., 224° C., 225° C., 295° C., 300° C., 320° C., 350° C., and any value within the range consisting of any two of the above values). Using the aforementioned preferred embodiments, it is possible to control the molecular structure of the product such as MWD and branch chain distribution while ensuring the conversion rate.

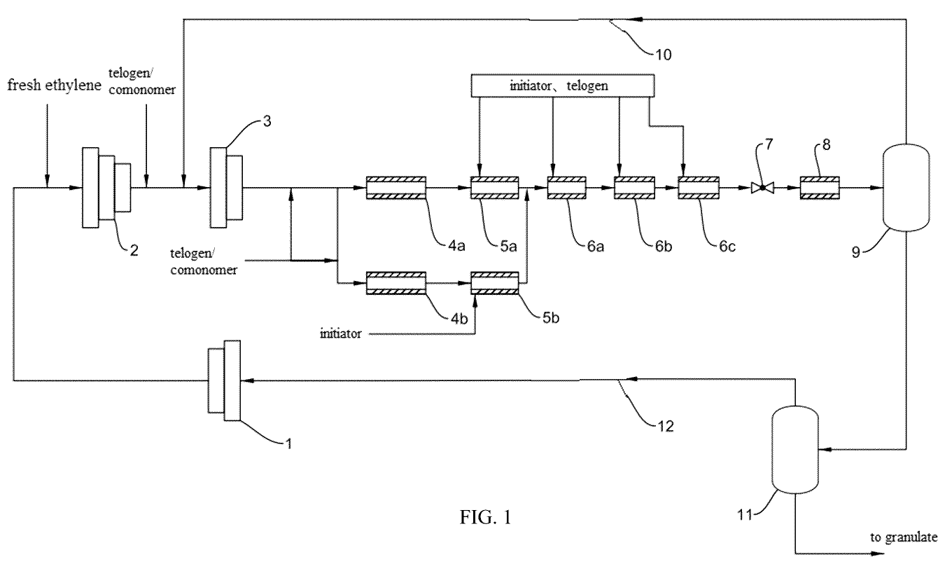

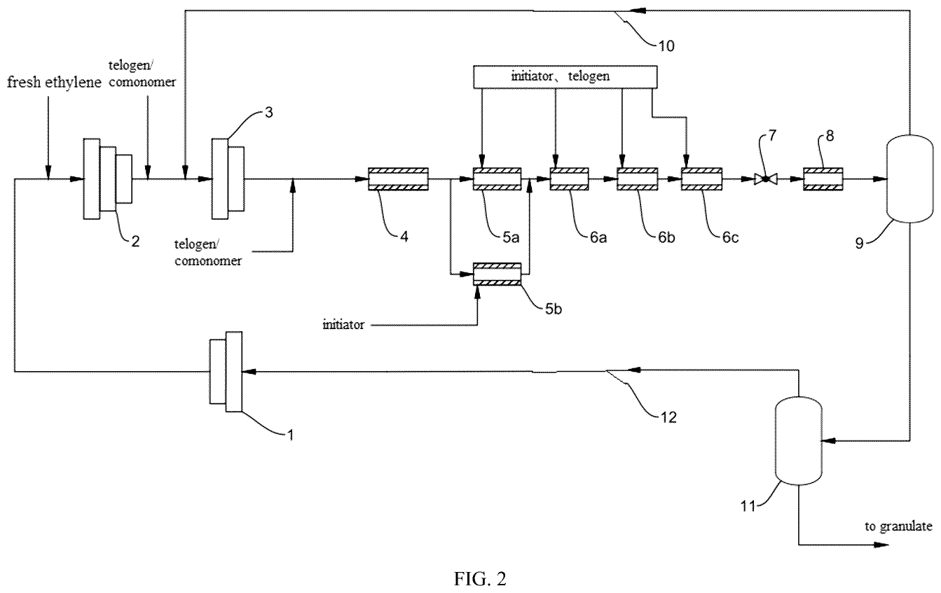

In the present invention, free radical polymerization is the main kind of polymerization. During the reaction process, the reaction temperature changes during the one-stage high-pressure polymerization and the multi-stage high-pressure polymerization, but the temperature changes are all within the range of 100-350° C. The addition of free radical polymerization initiator will affect the temperature of polymerization. In some embodiments of the present invention, the temperature of the materials in the reactor where the free radical polymerization initiator is injected through the initiator inlet is recorded as the “inlet temperature”; also record the peak temperature in the tubular reactor where the free radical polymerization initiator is introduced. In addition, it can be understood that when no free radical polymerization initiator is introduced into the tubular reactor, there is no free radical polymerization and temperature of the stream introduced into the tubular reactor does not change much, so the corresponding “inlet temperature” and “peak temperature” do not need to be recorded during this experiment. For example, as shown in FIGS. 1 and 2, there is no initiator inlet provided at the inlet of tubular reactor 6a, tubular reactor 6b, and tubular reactor 6c, that is, no free radical polymerization initiator is introduced into the tubular reactor 6a, the tubular reactor 6b, and the tubular reactor 6c, that is, the corresponding “inlet temperature” and “peak temperature” in the tubular reactor 6a, the tubular reactor 6b, and the tubular reactor 6c do not need to be recorded.

In the present invention, the feed amount of each reaction monomer stream containing olefin source is not limited and can be selected according to needs. In some preferred embodiments, the ratio of the maximum feed amount to the minimum feed amount of each reaction monomer stream containing olefin source is (20-1):1, such as 20:1, 15:1, 10:1, 5:1, 3:1, 1:1, and any value within the range consisting of any two of the above values, preferably (5-1):1. Ratios are by weight. Using the aforementioned preferred embodiments, different tubular reactors of one-stage high-pressure polymerization can be used to produce polymers with different molecular structural characteristics, thereby regulating the molecular structure of the final product. At the same time, it can reduce the difficulty of equipment design of tubular reactors for one-stage high-pressure polymerization.

In the present invention, the feed amount of each reaction monomer stream containing olefin source refers to the feed amount of each reaction monomer stream containing olefin source flowing into the tubular reactor in the one-stage high-pressure polymerization unit.

The at least two reaction monomer stream containing olefin source entering at least two parallel tubular reactors have a certain flow rate. Preferably, the flow rates of each of the olefin source-containing reaction monomer streams are between 5 m/s and 30 m/s respectively, such as 5 m/s, 6 m/s, 7 m/s, 7.24 m/s, 8 m/s, 10 m/s, 11 m/s, 12 m/s, 13 m/s, 14 m/s, 15 m/s, 16 m/s, 17 m/s, 18 m/s, 19 m/s, 20 m/s, 21 m/s, 22 m/s, 23 m/s, 24 m/s, 25 m/s, 26 m/s, 27 m/s, 28 m/s, 29 m/s, 30 m/s, and any value within the range consisting of any two of the above values, preferably between 8 m/s and 20 m/s. Using the aforementioned embodiments can reduce the problem of polymers in parallel tubular reactors adhering to the inner walls of the reaction tubes, ensuring the safety of the reaction tubes, thereby improving heat transfer efficiency and production efficiency of the tubular reactors. It can control the molecular structure of the product such as MWD and branch chain distribution while ensuring the conversion rate.

In the method of the present invention, as long as the purpose of the present invention can be achieved, the number of the one-stage high-pressure polymerization is not limited. In some preferred embodiments, the number of the one-stage high-pressure polymerization is 2-4. Under a certain flow rate of the reaction monomer stream containing olefin source, the greater the number of one-stage high-pressure polymerizations, the smaller the inner diameter of the reactor that needs to be performed for the one-stage high-pressure polymerization, which imposes stricter requirements on equipment. The aforementioned preferred embodiments can not only adjust the molecular chain structure of the product such as MWD and LCB, but also do not have so stringent requirements for the reaction equipment. However, this does not mean that more than 4 one-stage high-pressure polymerizations are not applicable to the present invention. According to the inventive concept of the present invention, as long as there are two or more one-stage high-pressure polymerization polymerizations, the object of the present invention can be achieved.

In the present invention, preferably, at least one free radical initiator is introduced to participate in one-stage high-pressure polymerization; at least one initiator is introduced to participate in multi-stage high-pressure polymerization. Using the aforementioned embodiments, product control can be achieved without decreasing the conversion rate of the reaction monomer stream containing olefin source and increasing apparatus fouling.

In the present invention, the free radical polymerization initiator is introduced intermittently or continuously to participate in one-stage high-pressure polymerization and/or multi-stage high-pressure polymerization.

In the present invention, as long as the purpose of the present invention can be achieved, the feed amount of each strand of the free radical polymerization initiator can be selected as needed, and there is no particular restriction in the present invention.

In the present invention, the molecular weight of the product can be changed by adding a telogen. In some embodiments, the method further includes feeding at least one strand of telogen to participate in the one-stage high-pressure polymerization and the multi-stage high-pressure polymerization respectively. Using the aforementioned embodiments, it can better control the concentration distribution of the telogen along the tubular reactor without increasing the fouling of the compressor system and changing the temperature of reaction section of the tubular reactor, thereby achieving adjustment of molecular chain structures such as MWD and LCB, and obtaining downstream products matching different fields in one apparatus.

In the present invention, as long as the purpose of the present invention can be achieved, the feed amount of each strand of the telogen can be selected as needed, and there is no particular restriction of that feed amount in the present invention.

In the present invention, the olefin copolymer can be prepared with adding copolymer monomers. In some embodiments, the method further includes feeding at least one strand of copolymer monomer to participate in the one-stage high-pressure polymerization and the multi-stage high-pressure polymerization respectively. The method of the present invention is not only suitable for homopolymerization of olefin initiated by free radical polymerization initiators, but also suitable for copolymerization of olefin and comonomer, thereby producing a variety of olefin homopolymerization and/or copolymerization products, improving apparatus utilization and applicability, and creating good economic effect.

In the present invention, in order to obtain polymer products, in some embodiments, the materials obtained by the multi-stage high-pressure polymerization are cooled under reduced pressure, and then unreacted monomers and polymer products are separated.

In the present invention, the olefins in the olefin source include one or more of R₂C═CR₂-type monoolefins, conjugated diolefins, and non-conjugated diolefins, where each R is H, hydrocarbyl or halogen respectively. For example, the olefin can be a monoolefin or a diolefin with a carbon number of 1 to 6. Specific examples include one or more of ethylene, propylene, butylene, isobutylene, 1,3-butadiene, pentadiene, and isoprene.

In the present invention, preferably, when the olefin source is ethylene and there is no copolymer monomer, the product prepared by the method of the present invention is linear LDPE.

In the present invention, the type of the copolymer monomer can be selected according to needs. It can be understood that the type of the copolymer monomer is different from that containing olefin source, and the copolymer monomer that can be free-radically copolymerized with the olefin source under high pressure are all the same applicable to the present invention. In some embodiments, when the olefin source is ethylene, examples of the copolymer monomers are C₃-C₈ α,β-unsaturated carboxylic acids, particularly acrylic acid, methacrylic acid, maleic acid, and fumaric acid; and/or C₃-C₈ α,β-unsaturated carboxylic acid derivatives, for example. C₃-C₈ α,β-unsaturated carboxylic acid ester or C₃-C₈ α,β-unsaturated carboxylic acid anhydride, especially methyl methacrylate, n-butyl methacrylate, tert-butyl methacrylate, methyl acrylate, ethyl acrylate, n-butyl acrylate, tert-butyl acrylate, methacrylic anhydride and maleic anhydride; and/or 1-olefins, for example, propylene, 1-butene, 1-pentene, 1-hexene, 1-octene and 1-decene. Preferably, copolymer monomers are one or more of propylene, 1-hexene, acrylic acid, n-butyl acrylate, tert-butyl acrylate, 2-ethylhexyl acrylate, vinyl acetate or vinyl acrylate.

In the present invention, in the case of preparing olefin copolymer, the ratio of olefin monomers and copolymer monomers is not limited and can be specifically selected according to actual needs.

In the present invention, the type of the free radical polymerization initiator is not limited. Any substance that can generate free radicals in one-stage high-pressure polymerization and/or multi-stage high-pressure polymerization can be used as the free radical polymerization initiator in the present invention. In some embodiments, the free radical polymerization initiator includes one or more of oxygen, air, azo compounds, organic peroxides, and hydrocarbons of C—C initiators. Examples of organic peroxides include peroxyesters, peroxyketals, peroxyketones and peroxycarbonates, such as di(2-ethylhexyl) peroxydicarbonate, dicyclohexyl peroxydicarbonate, diacetyl peroxydicarbonate, peroxyisopropyl tert-butyl carbonate, di-tert-butyl peroxide, di-tert-amyl peroxide, dicumyl peroxide, 2,5-dimethyl-2,5-di-tert-butylperoxyhexane, tert-butylcumyl peroxide, 2,5-dimethyl-2,5-di(tert-butylperoxy) hex-3-yne, 1,3-diisopropyl monohydroperoxide or tert-butyl hydroperoxide, didecanoyl peroxide, 2,5-dimethyl-2,5-bis(2-ethylhexanoylperoxy) hexane, tert-amyl peroxy-2-ethylhexanoate, dibenzoyl peroxide, tert-butyl peroxy-2-ethylhexanoate, tert-butylperoxydiethylacetate, peroxy tert-butyl diethyl isobutyrate, tert-butyl peroxy-3,5,5-trimethylhexanoate, 1,1-di(tert-butylperoxy)-3,3,5-trimethyl cyclohexane 1,1-di(tert-butylperoxy)cyclohexane, tert-butyl peracetate, cumyl peroxyneodecanoate, tert-amyl peroxyneodecanoate, neoperoxyne tert-amyl valerate, tert-butyl peroxyneodecanoate, tert-butyl permaleate, tert-butyl peroxypivalate, tert-butyl peroxyisononanoate, dicumyl hydrogen peroxide, hydrogen cumene peroxide, tert-butyl peroxybenzoate, methyl isobutyl ketone hydroperoxide, 3,6,9-triethyl-3,6,9-trimethyltriperoxycyclononane, 2,2-di(tert-butylperoxy) butane, etc. Examples of azo compounds include: azoalkanes (diazenes), azodicarboxylic acid esters, azodicarboxylic acid dinitriles, azodicarboxylic acid dinitriles, azobisisobutyronitrile, etc. Examples of hydrocarbons of C—C initiators include 1,2-diphenyl-1,2-dimethylethane derivatives, 1,1,2,2-tetramethylethane derivatives, etc. The free radical polymerization initiator of the present invention can be used alone, or a plurality of different types of free radical polymerization initiators can be mixed and used.

In the present invention, the free radical polymerization initiator can be introduced in any state, such as liquid, dissolved state, and supercritical state. Preferably, when a gaseous free radical polymerization initiator (such as oxygen or air) is used, the gaseous radical polymerization initiator is introduced in a supercritical state.

In the present invention, preferably, when the initiator is one or more of azo compounds, organic peroxides and hydrocarbons of C—C initiators, the free radical polymerization initiator is in a dissolved state; More preferably, the concentration of the free radical polymerization initiator in the dissolved free radical polymerization initiator is 5-80 wt %.

In the present invention, the term “dissolved free radical polymerization initiator” refers to a mixture of a solvent capable of dissolving free radical polymerization initiator and the corresponding free radical polymerization initiator. The type of solvent in the present invention is not limited but can dissolve the corresponding free radical polymerization initiator. Examples of suitable solvents include ketones, aliphatic hydrocarbons (such as octane, decane, isododecane, etc.) and other saturated C₈-C₂₅ hydrocarbons. Using the aforementioned preferred embodiments not only avoids pyrolysis of the free radical polymerization initiator caused by overheating, making the reaction safer, but also improves the efficiency of the initiator and reduces the cost of using the initiator.

In the present invention, as long as the purpose of the present invention can be achieved, there is no restriction on the type of telogen. Any telogen that can change the molecular weight of the product can be used in the present invention. In some embodiments, the telogen includes one or more of aliphatic hydrocarbons, olefins, ketones, aldehydes, aliphatic alcohols, or hydrogen. Examples of aliphatic hydrocarbons include propane, butane, pentane, hexane, cyclohexane, etc. Examples of alkenes include propylene, 1-pentene or 1-hexene. Examples of ketones include acetone, methylethyl ketone (2-butanone), methyl isobutyl ketone, methyl isopentyl ketone, diethyl ketone, dipentyl ketone, etc. Examples of aldehydes include formaldehyde, acetaldehyde or propionaldehyde. Examples of aliphatic alcohols include methanol, ethanol, propanol, isopropyl alcohol, butanol, etc. Preferably, the telogen is one or more of aliphatic aldehydes (such as propionaldehyde), 1-olefins (such as propylene or 1-hexene) and aliphatic hydrocarbons (such as propane).

In the present invention, the pressures involved are all absolute pressures.

As shown in FIGS. 1-2, the second aspect of the present invention provides a apparatus for the method of olefin free radical polymerization of the present invention. The apparatus includes:

One-stage high-pressure polymerization unit and multi-stage high-pressure polymerization unit. Among which:

The one-stage high-pressure polymerization unit is connected in series upstream of the multi-stage high-pressure polymerization unit;

The one-stage high-pressure polymerization unit includes at least two parallel tubular reactors for conducting one-stage high-pressure polymerization respectively on at least two reaction monomer streams containing olefin source;

The multi-stage high-pressure polymerization unit includes one or more serial tubular reactors for multi-stage high-pressure polymerization of the product from the one-stage high-pressure polymerization unit;

At least one tubular reactor in the one-stage high-pressure polymerization unit and/or the multi-stage high-pressure polymerization unit is provided with an initiator inlet.

Compared with current technologies for producing polyolefins in tubular reactors, polyolefin products with wider MWD and higher PDI can be produced by the apparatus of the present invention through the arrangement of the one-stage high-pressure polymerization unit including at least two parallel tubular reactors and the multi-stage high-pressure polymerization unit including one or more serial tubular reactors. The inventor speculates that it can better control the reaction time at high and low temperatures during polymerization through the setting of the one-stage high-pressure polymerization unit including at least two parallel tubular reactors, thereby increasing the PDI. In addition, it can better control the temperature, the pressure and other parameters of the tubular reactor inlet to achieve product control without decreasing the conversion rate of the reaction monomer stream containing olefin source and increasing the apparatus fouling by setting different positions of the initiator inlets.

In the apparatus of the present invention, the position of the initiator inlet is not limited and can be selected according to needs. In some embodiments, the reaction monomer stream inlet of at least one tubular reactor in the one-stage high-pressure polymerization unit is provided with initiator inlet. In some embodiments, at least one tubular reactor in the one-stage high-pressure polymerization unit is provided with at least one (for example, 1, 2, 3, 4, etc.) initiator inlet along its length direction, preferably 1-3 initiator inlet (it means one or more tubular reactors in the one-stage high-pressure polymerization unit are provided with 1-3 initiator inlet along its length direction respectively). In some embodiments, at least one tubular reactor in the multi-stage high-pressure polymerization unit is provided with at least one (for example, 1, 2, 3, 4, etc.) initiator inlet along length direction of the tubular reactor including material inlet (“material inlet” refers to the inlet that receives the material from the one-stage high-pressure polymerization unit and the adjacent tubular reactor), preferably 1-5 initiator inlet (it means one or more tubular reactors in the one-stage high-pressure polymerization unit are provided with 1-3 initiator inlet along its length direction respectively). By using the aforementioned embodiments, it can better adjust the molecular chain structure of the product (such as MWD and LCB) and produce downstream products that match different fields by the apparatus of the present invention.

Among them, the “reaction monomer stream inlet” refers to the end of the tubular reactor in the one-stage high-pressure polymerization unit where the reaction monomer stream flow into. Those skilled in this field should understand that the other end of the tubular reactor is the outlet; the inlet of the tubular reactor in the multi-stage high-pressure polymerization unit refers to the end of the first tubular reactor in the multi-stage high-pressure polymerization unit where the product from the one-stage high-pressure polymerization unit flow into.

In the apparatus of the present invention, as long as the purpose of the present invention can be achieved, there is no limit to the number of parallel tubular reactors in the one-stage high-pressure polymerization unit. In some preferred embodiments, the one-stage high-pressure polymerization unit includes 2-4 parallel tubular reactors. Using the aforementioned preferred embodiments, the molecular chain structure such as MWD and LCB of product can be adjusted.

In the apparatus of the present invention, in order to ensure that each reaction monomer stream containing olefin source has an inlet pressure for entering the one-stage high-pressure polymerization unit, in some embodiments, the apparatus further includes at least one compression unit upstream of the high-pressure polymerization unit.

In the apparatus of the present invention, in order to ensure that each reaction monomer stream containing olefin source has an inlet temperature entering the one-stage high-pressure polymerization unit, in some embodiments, the apparatus further includes at least one preheater upstream of the one-stage high-pressure polymerization unit. Preferably, the preheater is located between the compression unit and the one-stage high-pressure polymerization unit. Using the aforementioned embodiment, one-stage high-pressure polymerization can occur more smoothly.

In the apparatus of the present invention, there is no limit to the number of compression units, as long as each reaction monomer stream containing olefin source has an inlet pressure for entering the one-stage high-pressure polymerization unit. The compression unit includes one (or more serially connected, for example, 2 serially connected, 3 serially connected, 4 serially connected, 5 serially connected) compressors. Preferably, the compression unit includes 2-4 serial compressors. In some embodiments, the compression unit includes two serial compressors, namely the first-stage compressor 2 and the second-stage compressor 3. In other embodiments, the compression unit includes three serial compressors, namely in order the first-stage compressor 2, the second-stage compressor 3 and the third-stage compressor. Using the aforementioned embodiment, each reaction monomer stream can reach the inlet pressure of the one-stage high-pressure polymerization unit.

In the apparatus of the present invention, in some preferred embodiments, at least one compression unit is arranged serially upstream of at least two parallel tubular reactors in the one-stage high-pressure polymerization unit. In some embodiments, at least one compression unit is arranged serially at the respectively corresponding upstream of the tubular reactors in the one-stage high-pressure polymerization unit.

In the apparatus of the present invention, there is no limit to the number of the preheaters, as long as each reaction monomer stream containing olefin source has an inlet temperature for entering the one-stage high-pressure polymerization unit. In some preferred embodiments, at least one preheater is arranged serially upstream of at least two parallel tubular reactors in the one-stage high-pressure polymerization unit. In some embodiments, at least one preheater is arranged serially at the respectively corresponding upstream of the tubular reactors in the high-pressure polymerization unit.

In the apparatus of the present invention, preferably, the apparatus further includes at least one (for example, 1, 2, 3, 4, 5, 6, etc.) telogen inlet. The telogen inlet can be used to introduce the telogen into the apparatus to participate in one-stage high-pressure polymerization and/or multi-stage high-pressure polymerization, which can better adjust the molecular weight of the product.

In the apparatus of the present invention, the number and position of the telogen inlets are not limited and can be selected according to needs. In some preferred embodiments, the telogen inlets are provided at any position upstream of the outlet of the multi-stage high-pressure polymerization unit, that is, according to the needs of the product, the telogen inlets can be set at any position upstream of the outlet of the last tubular reactor in the multi-stage high-pressure polymerization unit.

In the apparatus of the present invention, each of the telogen inlets can be arranged in various ways. Preferably, each of the telogen inlets is respectively provided at: the inlets of the compression unit; and/or the outlet of the compression unit; and/or the connecting pipe of any two adjacent compressors in the compression unit; and/or the reaction monomer stream inlets of at least one tubular reactor in the one-stage high-pressure polymerization unit (referring to the connecting pipe between at least one tubular reactor in the one-stage high-pressure polymerization unit and its corresponding upstream compression unit); and/or on at least one tubular reactor in the one-stage high-pressure polymerization unit (including any position along the length of the reaction monomer stream inlets of the tubular reactor and the tubular reactor); and/or at the connecting pipe between the one-stage high-pressure polymerization unit and the multi-stage high-pressure polymerization unit; and/or on at least one tubular reactor in the multi-stage high-pressure polymerization unit (including the inlet of the tubular reactor and any position along the length of a tubular reactor). Using the aforementioned various embodiments, polyolefins with different MWD can be produced as needed.

In the apparatus of the present invention, preferably, the apparatus further includes at least one (for example, 1, 2, 3, 4, 5, 6, etc.) copolymer monomer inlet. The arrangement of the copolymer monomer inlet can be used to introduce the copolymer monomer into the apparatus to participate in one-stage high-pressure polymerization and/or multi-stage high-pressure polymerization, so as to utilize the apparatus to produce polyolefin copolymers.

In the apparatus of the present invention, there is no limitation on the number and position of the copolymer monomer inlets, which can be selected according to the needs. In some preferred embodiments, the copolymer monomer inlets are set at an arbitrary position upstream of the outlet of a one-stage high-pressure polymerization unit, i.e., they can be selected at an arbitrary position upstream of the outlet of at least one tubular reactor at the outlet of the one-stage high-pressure polymerization unit according to the need of the product.

In the apparatus of the present invention, each copolymer monomer inlet can be arranged in various ways. Preferably, each of the copolymer monomer inlets is respectively provided at: the inlet of the compression unit; and/or at the connecting pipe of any two adjacent compressors in the compression unit; and/or at the side of the reaction monomer stream inlet of at least one tubular reactor of the one-stage high-pressure polymerization unit; and/or the connecting pipe between the preheater and the compression unit.

In the apparatus of the present invention, preferably, the apparatus further includes a separation and circulation unit located downstream of the multi-stage high-pressure polymerization unit for separating the materials obtained by the multi-stage high-pressure polymerization to obtain polymerized products and unreacted monomers. Using the aforementioned embodiments, not only polymer products can be obtained, but unreacted monomers can also be recycled into one-stage high-pressure polymerization and multi-stage high-pressure polymerization.

In the apparatus of the present invention, as long as the purpose of the present invention can be achieved, the structure of the separation and circulation unit is not limited. In some preferred embodiments, the separation and circulation unit includes a separator and a circulation loop. The separator is used to separate the products from the multi-stage high-pressure polymerization unit, and the circulation loop is used to circulate unreacted monomers to the upstream of the one-stage high-pressure polymerization unit; further preferably, the separator includes high-pressure units separator 9 and low pressure separator 11 connecting serially. The circulation loop includes a high circulation loop 10 connected to the high pressure separator 9 and a low circulation loop 12 connected to the low pressure separator 11. More preferably, one end of the high circulation loop 10 is connected to the high-pressure separator 9 while the other end is connected to the suction side of the two-stage compressor 3; one end of the low circulation loop 12 is connected to the low-pressure separator 11, and the other end is connected to the suction side of the first-stage compressor 2.

In the apparatus of the present invention, preferably, the separation and circulation unit also includes a high-pressure relief valve 7 and a cooler 8 between the second-stage reactor and the low-pressure separator 11, for decompressing and cooling the materials from the multi-stage high-pressure polymerization unit and then introducing them into the separation and circulation unit for separation and circulation. In the apparatus of the present invention, preferably, the high circulation loop 10 also includes a cooler and a separator for removing some components (e.g. oligomers) that are not unreacted monomers from the gaseous fraction from the high-pressure separator 9. In the apparatus of the present invention, preferably, the low circulation loop 12 also includes a cooler and a separator for removing some components (such as oligomers) that are not unreacted monomers from the gaseous fraction from the low-pressure separator 11; further preferably, the low circulation loop 12 also includes at least one (for example, one, two, three, etc.) circulating material compressor 1; further preferably, the circulating material compressor 1 is provided downstream of the cooler and separator in the low circulation circuit 12. Using the aforementioned embodiments, not only polymer products can be obtained, but unreacted monomers can also be better recycled, resulting in better economic effects.

In the present invention, specifically, the apparatus of the present invention is used to pass the product obtained by the multi-stage high-pressure polymerization in the method of the present invention through the high-pressure relief valve 7 and the cooler in sequence into the high-pressure separator of the separation and circulation unit to get separated into the gaseous fraction A and the liquid fraction A. And the liquid fraction A flows into the low-pressure separator 11 in the separation and circulation unit to be separated into the gaseous fraction B and the polymer product. Further preferably, the gaseous fraction A passes through the cooler and separator in the high circulation loop 10 and is cooled and separated to obtain unreacted monomer and then flows into the suction side of the second-stage compressor 3; and/or the gaseous fraction B passes through the cooler and separator in the low circulation loop 12 is cooled and separated to obtain unreacted monomer and then flows into the suction side of the primary compressor 2; and/or the polymer is sent to be granulated to obtain the corresponding product.

In the present invention, as long as the purpose of the present invention can be realized, the cooling and separation conditions of the coolers and the separators in the high-pressure separator, the low-pressure separator 11, the high-circulation loop 10 and the low-circulation loop 12 are not limited, and the person skilled in this field can select them according to the needs.

In the apparatus of the present invention, the specific structures of the compressors, the tubular reactors, the high-pressure relief valve 7, the coolers, the high-pressure separator 9, the low-pressure separator 11, and the separators are not particularly limited, and they can be the apparatuses commonly used in this field, which are all well known to those skilled in this field and will not be described in detail here. In the present invention, each material inlet or material outlet can be cross-connected, each equipment is connected through pipelines, the apparatus is also equipped with valves and other components to realize the flow of materials, and cooling jacket structures are selected for the tubular reactor to realize heat exchange. The invention has no special requirements for this, so no further details will be given here.

In the present invention, those skilled in this field can adjust the method of the present invention according to changes in the apparatuses required for different embodiments of the present invention, which will not be described in detail here.

The present invention will be described in detail below through examples. In the following examples, the number average molecular weight Mₙ, the weight average molecular weight M_{w} and the polymer dispersion index PDI were measured by high temperature gel permeation chromatography (HT-GPC).

### Example 1

Olefin radical polymerization is carried out using an apparatus as shown in FIG. 1. In the apparatus shown in FIG. 1: the lengths of two parallel tubular reactors 5a and 5b are 560 m and the inner diameters are 0.045 m; the lengths of the three serial tubular reactors 6a, 6b, and 6c in the multi-stage high-pressure polymerization unit all are 400 m, and the inner diameters are 0.045 m; the reaction monomer stream inlets of tubular reactor 5a and tubular reactor 5b are both each equipped with an initiator inlet; tubular reactor 6a, tubular reactor 6b and tubular reactor 6c are each provided with an initiator inlet; the outlet of the compression unit is provided with a telogen inlet.

A strand of material containing olefin source is sequentially compressed by the first-stage compressor 2 and the second-stage compressor 3 in the compression unit. A strand of telogen is fed to the outlet of the compression unit through the telogen inlet. After the telogen and the compressed olefin source material are fully mixed at the outlet of the compression unit, the mixture is divided into two reaction monomer streams containing the olefin source in equal amounts. The two reaction monomer streams containing the olefin source pass through the preheater 4a located upstream of the tubular reactor 5a and the preheater 4b located upstream of the tubular reactor 5b respectively. And then they are introduced into the two parallel tubular reactors 5a and 5b in the one-stage high-pressure polymerization unit, each of which performs one-stage high-pressure polymerization respectively. And then the product of the one-stage high-pressure polymerization flows into tubular reactors 6a, tubular reaction 6b, and tubular reaction 6c in the multi-stage high-pressure polymerization unit, each of which performs multi-stage high-pressure polymerization. Among them, five strands of free radical polymerization initiators respectively fed through the initiator inlets included in the apparatus are each introduced to participate in the corresponding one-stage high-pressure polymerization or multi-stage high-pressure polymerization. The multi-stage high-pressure polymerization products pass through the high-pressure relief valve 7 and the cooler 8 in the separation and circulation unit in sequence and then flow into the high-pressure separator 9 in the separation and circulation unit to be separated into the gaseous fraction A and the liquid fraction A. The liquid fraction A flows into the low-pressure separator 11 in the separation and circulation unit to be separated into the gaseous fraction B and the polymer product. The gaseous fraction A passes through the cooler and separator in the high circulation loop 10 being cooled and separated, and then the unreacted monomer is obtained and flows into the suction side of the second-stage compressor. The gaseous fraction B is cooled and separated by the cooler and the separator in the low circulation loop 12 to obtain the unreacted monomer. After being compressed by the circulating material compressor 1 in the low circulation loop, the unreacted monomer flows into the suction side of the first-stage compressor. The polymer product is sent to granulate to obtain the LDPE product. Wherein:

The material containing olefin source is ethylene.

The inlet pressures of the two reaction monomer streams entering the tubular reactor 5a and 5b are both 220 MPa.

The inlet temperature of two reaction monomer streams entering the tubular reactor 5a and 5b are respectively 170° C. and 180° C.

The telogen is propylene, and the feeding amount of the telogen is 250 kg/h.

The inlet temperatures of preheater 4a and preheater 4b are both 92° C.

The feed amounts of the reaction monomer stream at the reaction monomer stream inlet of tubular reactor 5a and 5b are both 21750 kg/h. The flow rates of the reaction monomer stream are 7.24 m/s and 7.31 m/s respectively and the densities are 527 kg/m³ and 522 kg/m³ respectively. The ratio of the density to the viscosity of the reaction monomer streams of the tubular reactor 5a and 5b are 5383 and 5383 respectively.

Along the direction of material flow, the compositions of the first free radical polymerization initiator and the second free radical polymerization initiator are ditertiarybutyl peroxide, tert-butyl peroxybenzoate, tert-butyl peroxy-2-ethylhexanoate and tert-butyl peroxyneopentarate in a mass ratio of 1:2:2:2, and the compositions of the third to fifth strands of free radical polymerization initiators are ditertiarybutyl peroxide, tert-butyl peroxybenzoate, tert-butyl peroxy-2-ethylhexanoate and tert-butyl peroxyneopentarate in a mass ratio of 10:2:1:1.

The feed amounts of free radical polymerization initiators at the initiator inlets of the reaction monomer stream inlets of tubular reactor 5a and 5b are 6.78 kg/h and 6.19 kg/h respectively.

The feed amounts of the free radical polymerization initiator at the initiator inlets of tubular reactor 6a, 6b and 6c are 7.33 kg/h, 7.44 kg/h, 7.80 kg/h respectively.

The temperatures of inlets of tubular reactor 6a, 6b and 6c are 192° C., 211° C., and 225° C. respectively.

The peak temperatures of tubular reactor 5a, 5b, 6a, 6b and 6c are all 295° C.

The separation conditions of the high-pressure separator are: 25 MPa, 235° C.

The separation conditions of the low-pressure separator are: 2 bar, 220° C.

The pressure drop of the one-stage high-pressure polymerization unit is 4.8 MPa, and the pressure drop of the multi-stage high-pressure polymerization unit is 30.6 MPa. The ratio of the sum of the pressure drop of the one-stage high-pressure polymerization unit and the pressure drop of the multi-stage high-pressure polymerization unit to the pressure drop of the one-stage high-pressure polymerization unit is 7.38:1.

The number average molecular weight Mₙ, the weight average molecular weight M_{w}, the PDI, the yield and the ethylene conversion rate of LDPE are shown in the Table 1.

### Example 2

According to the method of Example 1, the differences are:

Olefin radical polymerization is carried out using an apparatus as shown in FIG. 2. In the apparatus shown in FIG. 2, a preheater 4 is located upstream of two parallel tubular reactors 5a and 5b in the one-stage high-pressure polymerization unit. Material containing olefin source passes through the first-stage compressor 2 and the second-stage compressor 3 in the compression unit in sequence. The telogen passes through the telogen inlet to the outlet of the compression unit, fully mixing with the material containing olefin source after compressing, then divided into two equal amounts of reaction monomer streams containing olefin source and introduced into two parallel tubular reactors 5a and 5b in the one-stage high-pressure polymerization unit respectively. Wherein:

The temperatures of the two reaction monomer streams entering the tubular reactor 5a and 5b are both 170° C. The flow rates of the reaction monomer streams are both 7.24 m/s, and the densities of the reaction monomer streams are both 527 kg/m³. The ratio of the density to the viscosity of the reaction monomer streams in the tubular reactor 5a and 5b are both 5383.

The telogen is propylene. The feed amount of the telogen is 180 kg/h.

The inlet temperature of preheater 4 is 92° C.

The feed amounts of the free radical polymerization initiator at the initiator inlets of the reaction monomer stream inlets of the tubular reactor 5a and 5b are both 6.80 kg/h.

The feed amounts of the free radical polymerization initiator at the initiator inlets at the inlet of the tubular reactor 6a, 6b and 6c are 7.41 kg/h, 7.26 kg/h, and 7.36 kg/h respectively.

The inlet temperatures of tubular reactor 6a, 6b and 6c are 192° C., 211° C., and 229° C. respectively.

The pressure drop of the one-stage high-pressure polymerization unit is 5.2 MPa, and the pressure drop of the multi-stage high-pressure polymerization unit is 33.5 MPa. The ratio of the sum of the pressure drop of the one-stage high-pressure polymerization unit and the pressure drop of the multi-stage high-pressure polymerization unit to the pressure drop of the one-stage high-pressure polymerization unit is 7.44:1.

The number average molecular weight Mₙ, the weight average molecular weight M_{w}, the PDI, the yield and the ethylene conversion rate of LDPE are shown in the Table 1.

### Example 3

According to the method of Example 1, the differences are:

In the apparatus shown in FIG. 1, there is no initiator inlet provided at the inlet of the tubular reactor 6a, 6b and 6c, and the two free radical polymerization initiators are each introduced to participate in the corresponding one-stage high-pressure polymerization respectively through the initiator inlets included in the apparatus. Wherein:

The telogen is propylene. The feed amount of the telogen is 195 kg/h.

The feed amounts of the free radical polymerization initiator at the initiator inlets of the reaction monomer stream inlets of the tubular reactor 5a and 5b are 6.47 kg/h and 6.22 kg/h respectively.

The peak temperatures in the tubular reactor 5a and 5b are both 295° C.

The separation conditions of the high-pressure separator are: 23 MPa, 200° C.

The separation conditions of the low pressure separator are: 2 bar, 190° C.

The pressure drop of the one-stage high-pressure polymerization unit is 5.0 MPa, and the pressure drop of the multi-stage high-pressure polymerization unit is 28.1 MPa. The ratio of the sum of the pressure drop of the one-stage high-pressure polymerization unit and the pressure drop of the multi-stage high-pressure polymerization unit to the pressure drop of the one-stage high-pressure polymerization unit is 6.62:1.

The number average molecular weight Mₙ, the weight average molecular weight M_{w}, the PDI, the yield and the ethylene conversion rate of LDPE are shown in the Table 1.

### Example 4

According to the method of Example 1, the differences are:

In the apparatus shown in FIG. 1, the tubular reactor 5a is provided with a telogen inlet at the side of the reaction monomer stream inlet, and there is no telogen inlet set in other positions. The telogen passes through the telogen inlet, fully mixing with the reaction monomer stream flowing into the tubular reactor 5a and then introduced into the tubular reactor 5a to perform the corresponding one-stage high-pressure polymerization. Wherein:

The inlet temperatures of the two reaction monomer streams entering the tubular reactor 5a and 5b are respectively 170° C. and 190° C. The flow rates of the reaction monomer streams are 7.24 m/s and 7.37 m/s respectively. The densities of the reaction monomer streams are 527 kg/m³ and 518 kg/m³ respectively. The ratio of the density to the viscosity of the reaction monomer streams in the tubular reactor 5a and 5b are 5383 and 5424 respectively.

The telogen is propylene. The feed amount of the telogen is 170 kg/h.

The feed amounts of the free radical polymerization initiators at the initiator inlets of the reaction monomer stream inlets of the tubular reactor 5a and 5b are 6.71 kg/h and 6.25 kg/h respectively.

The feed amounts of the free radical polymerization initiators at the initiator inlets of the tubular reactor 6a, 6b and 6c are 7.32 kg/h, 7.42 kg/h and 7.78 kg/h respectively.

The inlet temperatures of tubular reactor 6a, 6b and 6c are 192° C., 211° C., and 224° C. respectively.

The pressure drop of the one-stage high-pressure polymerization unit is 5.1 MPa, and the pressure drop of the multi-stage high-pressure polymerization unit is 33.8 MPa. The ratio of the sum of the pressure drop of the one-stage high-pressure polymerization unit and the pressure drop of the multi-stage high-pressure polymerization unit to the pressure drop of the one-stage high-pressure polymerization unit is 7.63:1.

The number average molecular weight Mₙ, the weight average molecular weight M_{w}, the PDI, the yield and the ethylene conversion rate of LDPE are shown in the Table 1.

### Example 5

According to the method of Example 4, the differences are:

In the apparatus shown in FIG. 1, the tubular reactors 5a and 5b are each provided with a telogen inlet respectively at the side of the reaction monomer stream inlet, and there is no telogen inlet set in other positions. The two strands of telogen passes respectively through the telogen inlet, fully mixing with the reaction monomer streams flowing into the tubular reactor 5a and 5b and then introduced into the tubular reactor 5a and 5b to perform the corresponding one-stage high-pressure polymerization respectively. Wherein:

The telogen is propylene. The feed amounts of the telogen are both 97.5 kg/h.

The feed amounts of the free radical polymerization initiators at the initiator inlets of the reaction monomer stream inlets of tubular reactor 5a and 5b are 6.78 kg/h and 6.19 kg/h respectively.

The inlet temperatures of tubular reactor 6a, 6b and 6c are 192° C., 211° C., and 225° C. respectively.

The pressure drop of the one-stage high-pressure polymerization unit is 5.0 MPa, and the pressure drop of the multi-stage high-pressure polymerization unit is 32.9 MPa. The ratio of the sum of the pressure drop of the one-stage high-pressure polymerization unit and the pressure drop of the multi-stage high-pressure polymerization unit to The pressure drop is 7.58:1.

The number average molecular weight Mₙ, the weight average molecular weight M_{w}, the PDI, the yield and the ethylene conversion rate of LDPE are shown in the Table 1.

### Example 6

According to the method of Example 4, the differences are:

In the apparatus shown in FIG. 1, a telogen inlet is provided at the connecting pipe between the one-stage high-pressure polymerization unit and the multi-stage high-pressure polymerization unit. There is no telogen inlet set in other positions. The telogen passes through the telogen inlet into the connecting pipe between the one-stage high-pressure polymerization unit and the multi-stage high-pressure polymerization unit, fully mixing with the product of the one-stage high-pressure polymerization and then introduced into the multi-stage high-pressure polymerization unit. Wherein:

The inlet temperatures of the two reaction monomer streams entering the tubular reactor 5a and 5b are 170° C. and 150° C. respectively. The feed amounts of the reaction monomer streams are 7.24 m/s and 7.37 m/s respectively. The densities of the reaction monomer streams are 527 kg/m³ and 537 kg/m³ respectively. The ratio of the density to the viscosity of the reaction monomer streams in the tubular reactor 5a and 5b are 5383 and 5317 respectively.

The telogen is propylene. The feed amount of the telogen is 195 kg/h;

The feed amounts of the free radical polymerization initiators at the initiator inlets of the reaction monomer stream inlets of the tubular reactor 5a and 5b are 6.72 kg/h and 2.40 kg/h respectively.

The feed amounts of the free radical polymerization initiators at the initiator inlets of the tubular reactor 6a, 6b, and 6c are 7.35 kg/h, 7.42 kg/h and 7.81 kg/h respectively.

The inlet temperatures of tubular reactor 6a, 6b and 6c are 192° C., 211° C., and 224° C. respectively.

The temperature peak of tubular reactor 5b is 250° C., and the temperature peak of other tubular reactors are 295° C.

The pressure drop of the one-stage high-pressure polymerization unit is 5.6 MPa, and the pressure drop of the multi-stage high-pressure polymerization unit is 34.5 MPa. The ratio of the sum of the pressure drop of the one-stage high-pressure polymerization unit and the pressure drop of the multi-stage high-pressure polymerization unit to the pressure drop is 7.16:1.

The number average molecular weight Mₙ, the weight average molecular weight M_{w}, the PDI, the yield and the ethylene conversion rate of LDPE are shown in the Table 1.

### Example 7

According to the method of Example 1, the differences are:

Olefin radical polymerization is carried out using an apparatus as shown in FIG. 1. In the apparatus shown in FIG. 1, the lengths of two parallel tubular reactors 5a and 5b in the one-stage high-pressure polymerization unit serially connected upstream of the multi-stage high-pressure polymerization unit are both 560 m, and the inner diameters of them are both 0.030 m.

The feed amounts of the reaction monomer streams at the reaction monomer stream inlets of tubular reactor 5a and 5b are both 21750 kg/h. The flow rates of the reaction monomer streams are 16.29 m/s and 16.45 m/s respectively.

The feed amounts of the free radical polymerization initiator at the initiator inlets of the reaction monomer stream inlets of the tubular reactor 5a and 5b are 6.78 kg/h and 6.19 kg/h respectively.

The feed amounts of the free radical polymerization initiator at the initiator inlets at the inlet of tubular reactor 6a, 6b, and 6c are 8.00 kg/h, 5.05 kg/h, and 8.49 kg/h respectively.

The inlet temperatures of tubular reactor 6a, 6b, and 6c are 201° C., 235° C., and 215° C. respectively.

The pressure drop of the one-stage high-pressure polymerization unit is 21.8 MPa, and the pressure drop of the multi-stage high-pressure polymerization unit is 30.3 MPa. The ratio of the sum of the pressure drop of the one-stage high-pressure polymerization unit and the pressure drop of the multi-stage high-pressure polymerization unit to the pressure drop of the one-stage high-pressure polymerization unit is 2.39:1.

The number average molecular weight Mₙ, the weight average molecular weight M_{w}, the PDI, the yield and the ethylene conversion rate of LDPE are shown in the Table 1.

### Example 8

According to the method of Example 1, the differences are:

Olefin radical polymerization is carried out using an apparatus as shown in FIG. 1. In the apparatus shown in FIG. 1, the lengths of two parallel tubular reactors 5a and 5b in the one-stage high-pressure polymerization unit serially connected upstream of the multi-stage high-pressure polymerization unit are 560 m and 325 m respectively, and the inner diameters of them are 0.045 m and 0.024 m respectively. The feed amounts of the reaction monomer streams at the reaction monomer stream inlets of tubular reactor 5a and 5b are 37285 kg/h and 6215 kg/h respectively. The flow rates of the reaction monomer streams are 12.41 m/s and 7.47 m/s respectively.

The feed amounts of the free radical polymerization initiator at the initiator inlets of the reaction monomer stream inlets of the tubular reactor 5a and 5b are 10.62 kg/h and 2.45 kg/h respectively.

The feed amounts of the free radical polymerization initiator at the initiator inlets at the inlet of tubular reactor 6a, 6b, and 6c are 7.98 kg/h, 4.92 kg/h, and 8.32 kg/h respectively.

The inlet temperatures of tubular reactor 6a, 6b, and 6c are 199° C., 236° C., and 215° C. respectively.

The pressure drop of the one-stage high-pressure polymerization unit is 10.2 MPa, and the pressure drop of the multi-stage high-pressure polymerization unit is 30.5 MPa. The ratio of the sum of the pressure drop of the one-stage high-pressure polymerization unit and the pressure drop of the multi-stage high-pressure polymerization unit to the pressure drop of the one-stage high-pressure polymerization unit is 3.99:1.

The number average molecular weight Mₙ, the weight average molecular weight M_{w}, the PDI, the yield and the ethylene conversion rate of LDPE are shown in the Table 1.

### Comparative Example 1

According to the method of Example 1, the differences are:

In the apparatus shown in FIG. 1, the length of the tubular reactors 5a in the one-stage high-pressure polymerization unit serially connected upstream of the multi-stage high-pressure polymerization unit is 560 m, and the inner diameters of it is 0.045 m. There is no tubular reactor 5b and preheater 4b. Four initiator inlets are provided in the apparatus, which are respectively located at the reaction monomer stream inlet of the tubular reactor 5a and the inlet of the tubular reactor 6a, 6b and 6c. No initiator inlet is provided at other locations of the apparatus.

A strand of material containing olefin source is sequentially compressed by the first-stage compressor 2 and the second-stage compressor 3 in the compression unit. A strand of telogen is fed to the outlet of the compression unit through the telogen inlet to mix with the compressed olefin source material and then passing through the preheater 4a to obtain a reaction monomer stream containing olefin source. Four strands of free radical polymerization initiators are introduced through the initiator inlets included in the apparatus to participate in the corresponding one-stage high-pressure polymerization or multi-stage high pressure polymerization respectively. Wherein:

The inlet pressure of the reaction monomer stream entering the tubular reactor 5a is 220 MPa.

The inlet temperature of the reaction monomer stream entering the tubular reactor 5a is 175° C.

The feed amount of the reaction monomer stream at the monomer stream inlet of the tubular reactor 5a is 43500 kg/h.

The feed amounts of the free radical polymerization initiation at the initiator inlet at the reaction monomer stream inlet of tubular reactor 5a and the initiator inlet of tubular reactor 6a, 6b and 6c are 13.37 kg/h, 6.56 kg/h, 7.71 kg/h and 7.39 kg/h respectively.

The inlet temperatures of tubular reactor 6a, 6b and 6c are 206° C., 207° C., 228° C. respectively.

The peak temperatures of tubular reactor 5a, 6a, 6b and 6c are all 295° C.

The total pressure drop of the tubular reactor is 44.5 MPa.

The number average molecular weight Mₙ, the weight average molecular weight M_{w}, the PDI, the yield and the ethylene conversion rate of LDPE are shown in the Table 1.

### Comparative Example 2

According to the method of Example 2, the differences are:

In the apparatus shown in FIG. 2, the length of the tubular reactors 5a in the one-stage high-pressure polymerization unit serially connected upstream of the multi-stage high-pressure polymerization unit is 560 m, and the inner diameters of it is 0.045 m. There is no tubular reactor 5b. Four initiator inlets are provided in the apparatus, which are respectively located at the reaction monomer stream inlet of the tubular reactor 5a and the inlet of the tubular reactor 6a, 6b and 6c. No initiator inlet is provided at other locations of the apparatus.

A strand of material containing olefin source is sequentially compressed by the first-stage compressor 2 and the second-stage compressor 3 in the compression unit. A strand of telogen is fed to the outlet of the compression unit through the telogen inlet to mix with the compressed olefin source material and then passing through the preheater 4a to obtain a reaction monomer stream containing the olefin source. Four strands of free radical polymerization initiators are introduced through the initiator inlets included in the apparatus to participate in the corresponding one-stage high-pressure polymerization or multi-stage high pressure polymerization respectively. Wherein:

The inlet pressure of the reaction monomer stream entering the tubular reactor 5a is 220 MPa.

The inlet temperature of the reaction monomer stream entering the tubular reactor 5a is 175° C.

The feed amount of the reaction monomer stream at the monomer stream inlet of the tubular reactor 5a is 43500 kg/h.

The feed amount of the free radical polymerization initiation at the initiator inlet at the reaction monomer stream inlet of tubular reactor 5a and the initiator inlet of tubular reactor 6a, 6b and 6c are 13.34 kg/h, 6.54 kg/h, 7.36 kg/h and 6.82 kg/h respectively.

The inlet temperature of tubular reactor 6a, 6b and 6c are 206° C., 207° C., and 232° C. respectively.

The peak temperatures of tubular reactor 5a, 6a, 6b and 6c are all 295° C.

The total pressure drop of the tubular reactor is 46.1 MPa.

The number average molecular weight Mₙ, the weight average molecular weight M_{w}, the PDI, the yield and the ethylene conversion rate of LDPE are shown in the Table 1.

### Comparative Example 3

According to the method of Example 3, the differences are:

In the apparatus shown in FIG. 1, the length of the tubular reactors 5a in the one-stage high-pressure polymerization unit serially connected upstream of the multi-stage high-pressure polymerization unit is 560 m, and the inner diameters of it is 0.045 m. There is no tubular reactor 5b and preheater 4b. The apparatus is provided with an initiator inlet, which is located at the reaction monomer stream inlet of the tubular reactor 5a. No initiator inlet is provided at other locations of the apparatus.

A strand of material containing olefin source is sequentially compressed by the first-stage compressor 2 and the second-stage compressor 3 in the compression unit. A strand of telogen is fed to the outlet of the compression unit through the telogen inlet to mix with the compressed olefin source material and then passing through the preheater 4a to obtain a reaction monomer stream containing olefin source. A strand of free radical polymerization initiator is introduced through the initiator inlet included in the apparatus to participate in the corresponding one-stage high-pressure polymerization. Wherein:

The inlet pressure of the reaction monomer stream entering the tubular reactor 5a is 220 MPa.

The inlet temperature of the reaction monomer stream entering the tubular reactor 5a is 175° C.

The feed amount of the reaction monomer stream at the reaction monomer stream inlet of the tubular reactor 5a is 43500 kg/h.

The feed amount of the free radical polymerization initiator at the initiator inlet at the reaction monomer stream inlet of the tubular reactor 5a is 12.70 kg/h.

The peak temperature of tubular reactor 5a is 295° C.

The total pressure drop of the tubular reactor is 41.2 MPa.

The number average molecular weight Mₙ, the weight average molecular weight M_{w}, the PDI, the yield and the ethylene conversion rate of LDPE are shown in the Table 1.

### Comparative Example 4

According to the method of Example 2, the differences are:

In the apparatus shown in FIG. 2, a tubular reactor with a total length of 1760 m and an inner diameter of 0.045 m is used instead of the one-stage high-pressure polymerization unit and the multi-stage high-pressure polymerization unit. And an initiator inlet is provided at the inlet of the reaction monomer stream of the tube reactor and at 560 m, 960 m, and 1360 m along the length of the tubular reactor, respectively. A reaction monomer stream containing olefin source is introduced into the tubular reactor to carry out the high-pressure polymerization, and the free radical polymerization initiator is continuously fed into the apparatus through the initiator inlet to participate in the high-pressure polymerization. The product obtained by the high-pressure polymerization in Comparative example 4 is equivalent to the product obtained by multi-stage high-pressure polymerization in Example 1.

The inlet pressure of the reaction monomer stream entering the tubular reactor is 220 MPa.

The inlet temperature of the reaction monomer stream entering the tubular reactor is 175° C.

The telogen is propylene. The feed amount of the telogen is 170 kg/h.

The feed amount of the reaction monomer stream at the reaction monomer stream inlet of the tubular reactor is 43500 kg/h.

The feed amounts of the free radical polymerization initiator at the four initiator inlets at the reaction monomer stream inlet of the tubular reactor and at 560 m, 960 m, and 1260 m along the length of the tubular reactor are respectively 14.29 kg/h, 7.40 kg/h, 7.27 kg/h, 7.32 kg/h respectively.

The inlet temperatures at the reaction monomer stream inlet of the tubular reactor and at 560 m, 960 m, and 1260 m along the length of the tubular reactor are 193° C., 211° C., and 229° C. respectively.

The peak temperatures at the reaction monomer stream inlet of the tubular reactor and at 560 m, 960 m and 1260 m along the length of the tubular reactor are all 295° C.

The total pressure drop of the tubular reactor is 47.6 MPa.

The number average molecular weight Mₙ, the weight average molecular weight M_{w}, the PDI, the yield and the ethylene conversion rate of LDPE are shown in the Table 1.

### Comparative Example 5

According to the method of Example 6, the differences are:

In the apparatus shown in FIG. 1, the length of the tubular reactors 5a in the one-stage high-pressure polymerization unit serially connected upstream of the multi-stage high-pressure polymerization unit is 560 m, and the inner diameters of it is 0.045 m. There is no tubular reactor 5b and preheater 4b. Four initiator inlets are provided in the apparatus, which are respectively located at the reaction monomer stream inlet of the tubular reactor 5a and the inlet of the tubular reactor 6a, 6b and 6c. No initiator inlet is provided at other locations of the apparatus. A telogen inlet is provided at the connecting pipe between the tubular reactor 5a and the multi-stage high-pressure polymerization unit. No telogen inlet is set at other positions of the apparatus. A strand of telogen is fed into the connecting pipe between the tubular reactor 5a in the one-stage high-pressure polymerization unit and the multi-stage high-pressure polymerization unit through the telogen inlet to fully mix with the one-stage high-pressure polymerization product and then flowing into the multi-stage high-pressure polymerization unit. Wherein:

The inlet pressure of the reaction monomer stream entering the tubular reactor 5a is 220 MPa.

The inlet temperature of the reaction monomer stream entering the tubular reactor 5a is 175° C.

The feed amount of the reaction monomer stream at the monomer stream inlet of the tubular reactor 5a is 43500 kg/h.

The feed amount of the free radical polymerization initiation at the initiator inlet at the reaction monomer stream inlet of tubular reactor 5a and the initiator inlet of tubular reactor 6a, 6b and 6c are 13.19 kg/h, 6.58 kg/h, 7.68 kg/h and 7.38 kg/h respectively.

The inlet temperature of tubular reactor 6a, 6b and 6c are 205° C., 208° C., and 228° C. respectively.

The peak temperatures of tubular reactor 5a, 6a, 6b and 6c are all 295° C.

The total pressure drop of the tubular reactor is 48.3 MPa.

The number average molecular weight Mₙ, the weight average molecular weight M_{w}, the PDI, the yield and the ethylene conversion rate of LDPE are shown in the Table 1.

TABLE 1

| | | | | | | Total |
|---|---|---|---|---|---|---|
| | | | | | Ethylene | reactor |
| | | | | | conversion | pressure |
| serial | Mₙ | M_{w} | | Output | rate | drop |
| number | [g/mol] | [g/mol] | PDI | [kg/h] | [%] | [MPa] |
| Example 1 | 13692 | 82355 | 6.01 | 15298 | 35.17 | 35.4 |
| Example 2 | 15838 | 109537 | 6.91 | 15327 | 35.23 | 38.7 |
| Example 3 | 18708 | 61614 | 3.29 | 4452 | 10.23 | 33.1 |
| Example 4 | 16113 | 129673 | 8.04 | 15291 | 35.15 | 38.9 |
| Example 5 | 15251 | 97854 | 6.42 | 15296 | 35.16 | 37.9 |
| Example 6 | 16966 | 163550 | 9.64 | 15480 | 35.59 | 40.1 |
| Example 7 | 13404 | 80022 | 5.99 | 14655 | 33.68 | 52.1 |
| Example 8 | 13405 | 79894 | 5.96 | 14460 | 33.24 | 4 0.7 |
| Comparative | 13633 | 80966 | 5.94 | 14968 | 34.41 | 44.5 |
| Example 1 | | | | | | |
| Comparative | 15680 | 99586 | 6.35 | 14682 | 33.75 | 46.1 |
| Example 2 | | | | | | |
| Comparative | 18678 | 61335 | 3.28 | 4448 | 10.23 | 41.2 |
| Example 3 | | | | | | |
| Comparative | 16110 | 109045 | 6.77 | 14948 | 34.36 | 47.6 |
| Example 4 | | | | | | |
| Comparative | 16598 | 134610 | 8.11 | 14957 | 34.38 | 48.3 |
| Example 5 | | | | | | |

According to Table 1, it can be found that the apparatus in Example 1-8 of the present invention can control the inlet temperature of at least two parallel tubular reactors in the one-stage high-pressure polymerization unit, the peak temperature of reactor, telogen feeding position and other parameters according to the performance requirements of downstream products, so as to control the MWD of the product without reducing conversion rate. At the same peak temperature, through Examples 1-8 and Comparative Examples 1-5 in comparison, it can be also known that the apparatus of the present invention can produce products with a wider MWD, overcoming the shortcoming of the tubular method that cannot produce products which can be produced by the kettle reactor method. And it can produce polyethylene product with a higher ethylene conversion rate by the apparatus of the present invention. In addition, the method and the apparatus of the present invention have effects of convenient control, easy operation, and wide range of product.

Some preferred embodiments of the present invention also provide a method and a apparatus for free radical polymerization of ethylene.

The present invention also provides a method for free radical polymerization of ethylene, which includes: introducing a reaction monomer stream containing ethylene source into at least two parallel tubular reactors to react in the presence of an initiator; Part of the material from the outlet of at least one of the at least two parallel tubular reactors is recycled back to at least one of the at least two parallel tubular reactors for reaction; The remaining material from the outlet of the at least two parallel tubular reactors is continuously introduced into one or more tubular reactors connected in series to react in the presence of an initiator; the pressure of the reaction monomer stream containing ethylene source is greater than or equal to 100 MPa.

As previously mentioned, kettle reactors are capable of producing polyethylene products with higher LCB and wider MWD, while polyethylene products produced by tubular reactors have narrower MWD and lower LCB. The inventors have found that, compared to the prior technology, polyethylene products with higher LCB and wider MWD, which cannot be produced by the existing tubular reactors, can be produced by the use of the method and the apparatus with tubular reactors described in the present invention. The inventors hypothesized that the method of the present invention is capable of causing the newly generated free radicals to be transferred to the molecular chain of the polymer, thereby producing a polyethylene product with wider MWD and higher LCB, which broadens the application field of the tubular method, and improve the utilization efficiency of the raw material, resulting in a rise in the conversion rate and the yield.

According to the method of the present invention, in some preferred embodiments, the circulation ratio of materials at the outlet of the at least two parallel tubular reactors is less than 1, preferably less than or equal to 0.3, and more preferably 0.04-0.2, for example, 0.04, 0.05, 0.07, 0.09, 0.1, 0.12, 0.13, 0.15, 0.18, 0.2, and any value within the range consisting of any two of the above values. Using the aforementioned preferred embodiments, polyethylene products with different MWD can be obtained. In particular, polyethylene products with a wide MWD that cannot be produced by the tubular method in the prior technology can be obtained, while ensuring that better ethylene conversion rate and yield can be maintained.

In the method of the present invention, the term “circulation ratio” refers to the total mass of materials recycled from the outlet of the tubular reactor back to at least one tubular reactor of at least two parallel tubular reactors to the total mass of materials from all outlets of two parallel tubular reactors. At the same time, that the material from the outlet of at least one tubular reactor is recycled back to at least one tubular reactor of at least two parallel tubular reactors means as needed that part of the material from the outlet of one of the at least two parallel tubular reactors or the total material collected from the partial materials from the outlets of the multiple tubular reactors is recycled back to at least one tubular reactor of the at least two parallel tubular reactors, that part of the materials from multiple outlets is recycled respectively to multiple tubular reactions of the at least two parallel tubular reactors, or that material is recycled back to at least one tubular reactor of the at least two parallel tubular reactors in other ways as needed.

In the method of the present invention, it is understandable that some equipment needs to be used to achieve the circulation that part of the material from the outlet of at least one of the at least two parallel tubular reactors is recycled back to at least one of the at least two parallel tubular reactors for reaction, such as fluid suction and delivery apparatus. The fluid suction and delivery apparatus may have a pressure drop loss. Generally, the pressure drop is less than 60 MPa, preferably less than 30 MPa, further preferably less than 15 MPa (for example, the pressure drop is 15 MPa, 12 MPa, 8 MPa, 6 MPa, and any value within the range consisting of any two of the above values).

According to the method of the present invention, the pressure of the reaction monomer stream containing ethylene source flowing into at least two parallel tubular reactors can be selected as long as it can perform high-pressure free radical polymerization in the presence of the initiator. In some preferred embodiments, the pressure of the reaction monomer stream containing ethylene source flowing into at least two parallel tubular reactors is 140-300 MPa (for example, 140 MPa, 160 MPa, 220 MPa, 300 MPa, and any value within the range consisting of any two of the above values). Using the aforementioned embodiments, the chain growth rate and the ease of chain transfer during the reaction can be controlled as needed, thereby better controlling the distance between ethylene molecules and obtaining products with different densities and branch chain distributions, so that the method of the present invention can produce heavy packaging film materials, agricultural film materials, injection plastics, coating materials, medical packaging materials and other products.

According to the method of the present invention, the inlet pressure of the reaction monomer stream containing ethylene source into the polymerization unit can be adjusted through a pressure relief valve at the inlet of the tubular reactor.

In the method of the present invention, it can be understood that the inlet pressure of the reaction monomer stream containing ethylene source introduced into the corresponding tubular reactor through the fluid suction and delivery apparatus is equal to the pressure of the reaction monomer stream containing ethylene source (that is, the pressure before entering the fluid suction and delivery apparatus) minus the pressure drop existing in the fluid suction and delivery apparatus. In addition, it can be understood that the inlet pressure of the reaction monomer stream containing ethylene source that has not been introduced into the corresponding tubular reactor through the fluid suction and delivery apparatus is equal to the pressure of the reaction monomer stream containing ethylene source or the inlet pressure of the reaction monomer stream containing ethylene source reduced pressure through the pressure relief valve at the inlet side of the tubular reactor.

According to the method of the present invention, there is no limit to the reaction temperature in at least two parallel tubular reactors and one or more serial tubular reactors, as long as high-pressure free radical polymerization can occur. In some embodiments, the reaction temperatures in the one-stage high-pressure polymerization unit and the multi-stage high-pressure polymerization unit are 100-350° C. respectively (for example, 100° C., 130° C., 150° C., 170° C., 200° C., 250° C., 295° C., 300° C., 350° C., and any value within the range consisting of any two of the above values).

In the method of the present invention, it can be understood that the reaction temperature in at least two parallel tubular reactors and one or more serial tubular reactors is a temperature within a range. Specifically, inlet temperature, outlet temperature and peak temperature of the reaction zone in at least two parallel tubular reactors and one or more serial tubular reactors are all within the reaction temperature range.

According to the method of the present invention: In the at least two parallel tubular reactors and one or more serial tubular reactors, the outlet temperature of each reaction zone is less than or equal to the peak temperature of the corresponding reaction zone; In the at least two parallel tubular reactors and one or more serial tubular reactors, the inlet temperature of each reaction zone is less than the peak temperature of the corresponding reaction zone; Further preferably, in the at least two parallel tubular reactors and one or more serial tubular reactors, the absolute values of the difference between the outlet temperature of each reaction zone and the peak temperature of the corresponding reaction zone are 0-150° C. respectively (for example, 20° C., 50° C., 70° C., 100° C., 120° C., 150° C., and any value within the range consisting of any two of the above values), more preferably 20-120° C. Using the aforementioned embodiments, the temperature distribution in the reaction zone can be better controlled, and at the same time, polyethylene products with different MWD can be obtained.

In the method of the present invention, the temperature of the reaction monomer stream containing ethylene source flowing into at least two parallel tubular reactors can be obtained after being preheated by a preheating unit. In some preferred embodiments, the temperatures of the reaction monomer stream flowing into at least two parallel tubular reactors are 140-190° C. respectively (such as 140° C., 150° C., 170° C., 180° C., 190° C., and any value within the range consisting of any two of the above values). In some preferred embodiments, the peak temperature of each reaction zones in at least two parallel tubular reactors and one or more serial tubular reactors is 200-300° C. (for example, 200° C., 225° C., 260° C., 295° C., 300° C., and any value within the range consisting of any two of the above values). Using the aforementioned embodiments, the reaction zone can be better controlled temperature distribution, and polyethylene products with different MWD can be obtained.

According to the method of the present invention, in some preferred embodiments, the weight ratio of the maximum feed amount to the minimum feed amount of the reaction monomer stream containing ethylene source in the at least two parallel tubular reactors is 1:(0.01-1), such as 1:0.1, 1:0.5, 1:1, and any value within the range consisting of any two of the above values. Using the aforementioned preferred embodiments, different products with a wide range of molecular distributions can be obtained as needed.

According to the method of the present invention, in some preferred embodiments, at least two initiators are introduced into the at least two parallel tubular reactors respectively; at least one initiator participates in one or more serial tubular reactors. reaction in. Using the aforementioned embodiments, the newly generated free radicals can be better transferred to the molecular chain of the polymer, thereby producing polyethylene products with a wider MWD and LCB, and broadening the application field of products produced by the tubular method. It can also improve the utilization efficiency of raw materials, increase the conversion rate and the yield.

According to the method of the present invention, in some embodiments, the method of the present invention further includes at least one chain transfer agent participating in the reaction in at least two parallel tubular reactors and one or more serial tubular reactions. Using the aforementioned embodiments, using a chain transfer agent can transfer newly generated free radicals to the molecular chain of the polymer, thereby producing polyethylene products with a wider MWD and LCB, broadening the application field of the tubular method, improving the utilization efficiency of raw materials, and increasing the conversion rate and the yield.

According to the method of the present invention, in some embodiments, the method of the present invention further includes at least one comonomer participating in the reaction in at least two parallel tubular reactors and one or more serial tubular reactors. Using the aforementioned embodiments, the method of the present invention can also obtain different ethylene copolymers.

In the method of the present invention, the outlet of the comonomer supply unit can be installed at different positions of the apparatus included in the method of the present invention according to the needs of the present invention.

According to the present invention, in some preferred embodiments of the method, the method described herein further comprises polymerization product and unreacted monomer separated from the material obtained in one or more serial tubular reactors. In order to make the present invention economically efficient, it is further preferred that the unreacted monomer is recycled back to the upstream of at least two parallel tubular reactors to continue participating the reaction.

In the method of the present invention, the conditions for the cyclic separation can be selected as needed, and will not affect the purpose of the present invention, so they will not be described in detail here.

According to the method of the present invention, the specific selection of the initiator is not limited, and any initiator that can generate free radical substances under the reaction conditions of the present invention is suitable for use in the present invention. In some embodiments, the initiator is selected from one or more of azo compounds, organic peroxides, oxygen and air. At the same time, the initiator in the present invention can be used directly or dissolved in a solvent. Examples of azo compounds include azobisisobutyronitrile, azobisisovaleronitrile and azobisisoheptanitrile; examples of organic peroxides include 2,2-bis(tert-butylperoxy) propane, tert-butyl peroxy-2-ethylhexanoate, bis-(2-ethylhexyl peroxydicarbonate), di-tert-butyl peroxide, dialkyl peroxide, tert-butyl peroxybenzoate, 1,1-bis(tert-butylperoxy)cyclohexane, tert-butyl peroxypivalate.

In the present invention, the initiator can be introduced in any state, such as liquid, dissolved state or supercritical state. For example, when a gaseous free radical polymerization initiator such as oxygen or air is used, the initiator is introduced in a supercritical state.

In the present invention, the mixture of di-tert-butyl peroxide, tert-butyl peroxybenzoate, tert-butyl peroxy-2-ethylhexanoate and tert-butyl peroxypivalate is used as an example to illustrate advantages of the present invention, but the present invention is not limited thereto.

According to the method of the present invention, the type of the chain transfer agent is not limited. In some embodiments, the chain transfer agent is selected from one or more of aliphatic hydrocarbons, olefins, ketones, aldehydes, aliphatic alcohols and hydrogen. Examples of aliphatic hydrocarbons include propane, butane and cyclohexane; examples of olefins include propylene and hexene.

In the method of the present invention, any monomer that can be copolymerized with ethylene under high-pressure radical polymerization conditions can be used as the comonomer of the present invention, such as propylene and/or vinyl acetate.

In the method of the present invention, the ratio of the MWD of the low-density polyethylene obtained by the method of the present invention to the conversion rate of the ethylene source is greater than or equal to 0.01 and less than or equal to 0.05, preferably greater than or equal to 0.018 and less than or equal to 0.048.

The present invention also provides a apparatus for free radical polymerization of ethylene. The apparatus comprises: polymerization unit, fluid suction and delivery unit, and initiator supply unit. The polymerization unit comprises a one-stage high-pressure polymerization unit and a multi-stage high-pressure polymerization unit downstream of the one-stage high-pressure polymerization unit in series. The one-stage high-pressure polymerization unit comprises at least two parallel tubular reactors. The multi-stage high-pressure polymerization unit comprises one or more serial tubular reactors. The fluid suction and delivery unit comprises one or at least two parallel fluid suction and delivery apparatuses for intaking and delivery of at least one reaction monomers stream containing ethylene source and a portion of the material from the outlet of at least one tubular reactor in the first stage high-pressure polymerization unit. The initiator supply unit is used to introduce initiator into the polymerization unit.

In the apparatus of the present invention, it can be understood that the initiator supply unit supplies the initiator into the apparatus through the outlet of the initiator supply unit. The position and the number of the outlets of the initiator supply unit can be selected according to the position and the number of the corresponding reaction zones. At the same time, those skilled in the field can understand that when the initiator supply unit supplies the initiator into the polymerization unit, any connection point between an outlet of the initiator supply unit and the apparatus is the “reaction zone inlet”. Along the flow direction of the material, there is a zone where the temperature rises called “reaction zone”, and after the temperature rises to the peak temperature, the zone that the temperature begins to decrease is the corresponding “cooling zone”. When a unit has only one reaction zone in the direction of material flow, the outlet in the direction of material flow is “reaction zone outlet” or “cooling zone outlet”. When a unit has multiple reaction zones connected in series, along the flow direction of the material, the last outlet in the initiator supply unit which is located in the connection point in downstream of the adjacent last “reaction zone inlet” is the next “reaction zone inlet”, and at the same time is the “reaction zone outlet” or “cooling zone outlet” of the last reaction zone, and so on. The final “reaction zone outlet” or “cooling zone outlet” in the initiator supply unit is the outlet of the whole reaction. For example, the multi-stage high-pressure polymerization unit in the apparatus of the present invention includes two reaction zones connected in series, which means the first connection point between the first outlet of the initiator supply unit and the multi-stage high-pressure polymerization unit is the “first reaction zone inlet”. There is a zone with elevated temperature along the flow direction of the material, which is called the “first reaction zone.” After the temperature rises to the peak temperature, the area that the temperature begins to decrease is the corresponding “first cooling zone”. The second connection point between the second outlet of the initiator supply unit and the multi-stage high-pressure polymerization unit in the downstream of “first reaction zone inlet” along the flow direction of the material is the “second reaction zone inlet” and the “first reaction zone outlet” or the “first cooling zone outlet”. After the “second reaction zone inlet” along the flow direction of the material, there is a zone where the temperature rises which is called the “second reaction zone”. After the temperature rises to the peak temperature, the zone where the temperature begins to decrease is the corresponding “second cooling zone”. The outlet after the completed multi-stage high-pressure polymerization is the “second reaction zone outlet” or the “second cooling zone outlet”.

In the apparatus of the present invention, the tubular reactors in the one-stage high-pressure polymerization unit, the tubular reactors in the multi-stage high-pressure polymerization unit, the fluid suction and delivery apparatus, the initiator supply unit and so on may be set up with one or more inlets and outlets in accordance with the needs of material introduction and material delivery, which will not be elaborated herein. There is no limitation to the tubular reactor in the one-stage high-pressure polymerization unit and the multi-stage high-pressure polymerization unit. Preferably the tubular reactor is with the casing structure (for example, a single casing structure, or a multi-casing structure), the use of the reactor with the casing structure can be better control of the reaction temperature of the first high-pressure polymerization unit and multi-stage high-pressure polymerization unit of the apparatus of the present invention.

As previously mentioned, kettle reactors are capable of producing polyethylene products with higher branching degree and broader molecular weights, and tubular reactors produce polyethylene products with narrower MWD and lower content of long branched chains. The inventors have found that the use of the apparatus described herein is capable of producing polyethylene products with higher branching degree and broader molecular weights that cannot be produced by the existing tubular reactors as compared to the prior technology The inventors have hypothesized that when producing the products, the apparatus of the present invention with at least two parallel tubular reactors and a fluid suction and delivery unit for suctioning and conveying at least one reaction monomers stream containing ethylene source and a portion of the material from the outlet of at least one of the tubular reactors in the first stage of the high-pressure polymerization unit can enable the transfer of the newly generated free radicals to the molecular chain of the polymer, thus producing polyethylenes having a wider range of MWD and long chain branching degrees, broadening the application field of tubular products, improving the utilization efficiency of raw material, and also resulting in higher conversion rate and yield.

According to the apparatus of the present invention, as long as the purpose of the present invention can be achieved, the number of tubular reactors included in the one-stage high-pressure polymerization unit is not limited. In some preferred embodiments, the one-stage high-pressure polymerization unit includes 2-4 parallel tubular reactors. Using the aforementioned preferred embodiments, the molecular chain structure of the polyethylene product can be more flexibly controlled, which is conducive to the development of more new polyethylene products and the realization of flexible production.

According to the apparatus of the present invention, as long as the purpose of the present invention can be achieved, the number of reaction zones included in the multi-stage high-pressure polymerization unit is not limited. In some preferred embodiments, the multi-stage high-pressure polymerization unit includes 1 or 2-6 serial reaction zones; further preferably, 2-4 serial reaction zones. Using the aforementioned preferred embodiments, the MWD of the polyethylene product can be effectively adjusted as needed.

In the apparatus of the present invention, unless otherwise specified, the main function of the fluid suction and delivery apparatus is to inhale and convey materials. The specific selection of apparatus is not limited, including but not limited to jet pumps, and the number of fluid suction and delivery apparatus can be set as needed. At the same time, those skilled in this field will understand that the number of fluid suction and delivery apparatus is less than or equal to the number of strands of the reaction monomer stream containing ethylene source introduced into the tubular reactor in the one-stage high-pressure polymerization unit, and the number of tubular reactors in the one-stage high-pressure polymerization unit is greater than or equal to the number of strands of the reaction monomer stream containing ethylene source.

According to the apparatus of the present invention, in some embodiments, at least one fluid suction and delivery apparatus is arranged in series upstream of at least two parallel tubular reactors in the one-stage high-pressure polymerization unit.

According to the apparatus of the present invention, in order to enable the reaction monomer stream containing ethylene source to have an inlet pressure into the polymerization unit, in some embodiments, the apparatus of the present invention further includes a compression unit upstream of the fluid suction and delivery unit and the polymerization unit. Preferably, the compression unit includes at least a second-stage compressor.

According to the apparatus of the present invention, the specific number of stage of the compressor in the compression unit is not limited, as long as it can enable the reaction monomer stream containing ethylene source to have an inlet pressure into the polymerization unit.

According to the apparatus of the present invention, those skilled in this field can set a pressure relief valve at the inlet side of the tubular reactor in the one-stage high-pressure polymerization unit to better regulate inlet pressure of the reaction monomer stream containing ethylene source into the polymerization unit.

According to the apparatus of the present invention, in order to ensure that the reaction monomer stream containing ethylene source has a feed temperature into the polymerization unit, in some embodiments, the apparatus of the present invention further includes a preheating unit located upstream of the polymerization unit.

In the apparatus of the present invention, those skilled in this field can understand that at least second-stage compressor refer to at least two compressors connected in series. Compressor of each stage is provided with an air inlet and an air outlet. The air outlet of the upstream compressor is connected to the air inlet of its adjacent downstream compressor. The term “compression interstage” refers to the connecting pipe between two adjacent compressors.

According to the apparatus of the present invention, in some embodiments, at least one compression unit is disposed in series upstream of at least two parallel tubular reactors in the fluid suction and delivery unit; in some embodiments, at least one compression unit is arranged in series at the respectively corresponding upstreams of the fluid suction and delivery apparatus of the fluid suction and delivery unit.

According to the apparatus of the present invention, in some embodiments, the preheating unit includes one or more preheating apparatuses arranged in parallel, and the type of the preheating apparatus is not limited as long as it can achieve the purpose of preheating.

According to the apparatus of the present invention, in some embodiments, at least one preheating apparatus is arranged in series upstream of at least two parallel tubular reactors in the one-stage high-pressure polymerization unit; in some embodiments, at least one preheating apparatus is arranged in series at the respectively corresponding upstream of the tubular reactors in the one-stage high-pressure polymerization unit.

According to the apparatus of the present invention, in some embodiments, at least one preheating apparatus is arranged in series at the respectively corresponding upstream of each tubular reactor in the one-stage high-pressure polymerization unit; in some preferred embodiments, at least one preheating apparatus is located between the compression unit and the corresponding tubular reactor in the one-stage high-pressure polymerization unit; in some preferred embodiments, at least one preheating apparatus is located between the corresponding fluid suction apparatus in the fluid suction and delivery unit and the corresponding tubular reactors in the one-stage high-pressure polymerization unit. Using the aforementioned embodiments, when the fluid suction and delivery unit in the apparatus fails, the reaction monomer stream containing ethylene source can be divided into streams introduced into at least two tubular reactors in the one-stage high-pressure polymerization unit without passing through the fluid suction and delivery unit, which is without affecting production and can better regulate the flow rate of each reaction monomer stream containing ethylene source entering the one-stage high-pressure polymerization unit at the same time.

In the apparatus of the present invention, it can be understood that if the reaction monomer stream containing ethylene source itself already has the feed temperature for entering the polymerization unit, there is no need to provide a preheating unit.

In some preferred embodiments of the apparatus, according to the present invention, the apparatus of the present invention further includes a chain transfer agent supply unit for delivering the chain transfer agent into the apparatus. Using the aforementioned embodiment, the chain transfer agent supply unit can transfer newly generated free radicals to the molecular chain of the polymer, thereby producing polyethylene products with a wider range of MWD and LCB, and broadening the application field of products of the tubular method.

According to the apparatus of the present invention, in some preferred embodiments, at least one outlet of the chain transfer agent supply unit is connected to the respectively corresponding reaction monomer stream inlet side of the fluid suction and delivery apparatus; in some preferred embodiments, at least one outlet of the chain transfer agent supply unit is connected to any position on the tubular reactor in the one-stage high-pressure polymerization unit (including the reaction monomer stream inlet end of the tubular reactor and any position of the tubular reactor along the material flow direction); in some preferred embodiments, at least one outlet of the chain transfer agent supply unit is connected to the respectively corresponding reaction monomer stream inlet side of the preheating apparatus; in some preferred embodiments, at least one outlet of the chain transfer agent supply unit is connected to the common upstream of at least two parallel preheating apparatuses; in some preferred embodiments, at least one outlet of the chain transfer agent supply unit is connected to the common upstream of at least two parallel fluid suction and delivery apparatuses; in some preferred embodiments, at least one outlet of the chain transfer agent supply unit is connected to the inlet side of the multi-stage high-pressure polymerization unit (the inlet side that the material from the one-stage high-pressure polymerization unit flows into); in some preferred embodiments, at least one outlet of the chain transfer agent supply unit is connected to any position of the multi-stage high-pressure polymerization unit; in some preferred embodiments, at least one outlet of the chain transfer agent supply unit is connected to the inlet of the compression unit; in some preferred embodiments, at least one outlet of the chain transfer agent supply unit is connected to any position of the connecting pipe in compression interstage of the compression unit. Using the aforementioned preferred embodiments, the MWD of the initial amount of polymer at the outlet of the one-stage high-pressure polymerization unit can be adjusted, thereby better adjusting the MWD of the final product.

According to the apparatus of the present invention, in order to be able to produce the ethylene copolymer, in some embodiments, the apparatus of the present invention further includes a comonomer supply unit to introduce comonomer into the apparatus.

According to the apparatus of the present invention, the position and the number of the outlet of the comonomer supply unit in the apparatus can be selected according to needs. In some embodiments, at least one outlet of the comonomer supply unit is connected to the respectively corresponding reaction monomer stream inlets of the tubular reactors in the one-stage high-pressure polymerization unit; In some embodiments, at least one outlet of the comonomer supply unit is connected to the respectively corresponding reaction monomer stream inlets of the preheating apparatus; In some embodiments, at least one outlet of the comonomer supply unit is connected to the common upstream of at least two parallel preheating apparatuses; In some implementations, at least one outlet of the comonomer supply unit is connected to the respectively corresponding reaction monomer stream inlet side of the fluid suction and delivery apparatus; In some embodiments, at least one outlet of the comonomer supply unit is connected to the common upstream of at least two parallel fluid suction and delivery apparatuses; In some embodiments, at least one outlet of the comonomer supply unit is connected to the inlet of the compression unit; In some embodiments, at least one outlet of the comonomer supply unit is connected to any position of the connecting pipe in compression interstage of the compression unit. In the apparatus of the present invention, the application field of the apparatus of the present invention is further broadened by adopting the aforementioned embodiments.

According to the apparatus of the present invention, in some embodiments, the apparatus of the present invention also includes a separation circulation unit located downstream of the polymerization unit to separate polymer products and unreacted monomers. In some preferred embodiments, the unreacted monomers can be recycled as circulating materials to the upstream of the compression unit as needed, so that the economy of apparatus of the present invention is better.

In the apparatus of the present invention, as long as the purpose of the present invention can be achieved, the separation and circulation unit can be selected and configured according to specific needs, and will not be described in detail here.

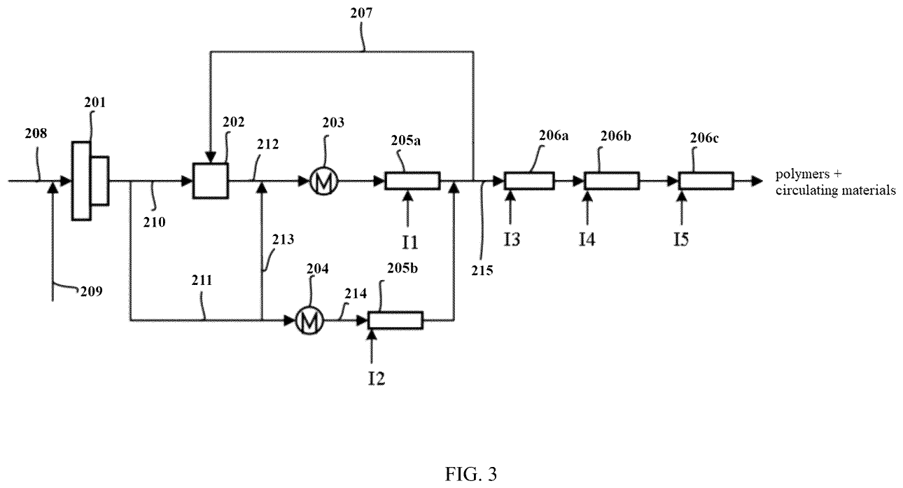

In the present invention, in some embodiments, the operation process of the method of the present invention using the apparatus of the present invention is explained with reference to FIG. 3:
A strand of chain transfer agent 209 is introduced through an outlet of the chain transfer agent supply unit connected to the inlet of the compression unit 201. The chain transfer agent 209 is mixed with a strand of material C208 which is fresh ethylene, and then compressed by the compression unit 201 and divided into two reaction monomer streams containing ethylene source, namely reaction monomer stream containing ethylene source A210 and reactive monomer stream containing ethylene source B211 respectively;
The reaction monomer stream containing ethylene source A210 is passed through the fluid suction and delivery apparatus 202 to obtain the reactive monomer stream containing ethylene source C212. The reaction monomer stream containing ethylene source C212 is mixed with the reaction monomer stream containing ethylene source D213 which is part of the reaction monomer stream containing ethylene source B211, and then preheated by the preheating apparatus A3 and introduced into the tubular reactor A in the one-stage high-pressure polymerization unit for reaction;
The remaining part of the reaction monomer stream containing ethylene source B211 is preheated by the preheating apparatus B204 to obtain the reaction monomer stream containing ethylene source E214. The reaction monomer stream containing ethylene source E214 passes through the pressure relief valve at the inlet side of tubular reactor B After reducing the pressure to the required inlet pressure of the tubular reactor B, the reaction monomer stream containing ethylene source E214 enters the tubular reactor B in the one-stage high-pressure polymerization unit for reaction;
After the materials flowing out from the tubular reactor 205a and the tubular reactor 205b are collected, they are divided into two streams of materials, namely material A207 and material B215 respectively;
Material A207 is recycled back to the fluid suction and delivery apparatus 202 and mixed with the reaction monomer stream containing ethylene source A210 that flows into the fluid suction and delivery apparatus 202. After flowing out, it continues to be mixed with the reaction monomer stream containing ethylene source D213 which is part of the reaction monomer stream containing ethylene source B211 and then preheated by the preheating apparatus A203 and introduced into the tubular reactor 205a in the one-stage high-pressure polymerization unit for reaction;
Material B215 flows into the tubular reactor in the multi-stage high-pressure polymerization unit for reaction;
After reaction, the materials flowing out from the multi-stage high-pressure polymerization unit are separated through the separation and circulation unit to obtain polymer and circulating materials, and the circulating materials are returned to the inlet end of the compression unit 201;
Among them, the first initiator I1 and the second initiator I2 enter the first reaction zone 205a and the second reaction zone 205b respectively and correspondingly through the first and second outlets of the initiator supply unit to participate in the reaction in the one-stage high-pressure polymerization unit; the third initiator I3, the fourth initiator I4, and the fifth initiator I5 enter the third reaction zone 206a, the fourth reaction zone 206b and the fifth reaction zone 206c respectively and correspondingly through the third, fourth, and fifth outlet of the initiator supply unit to participate in the reaction in the multi-stage high-pressure polymerization unit.

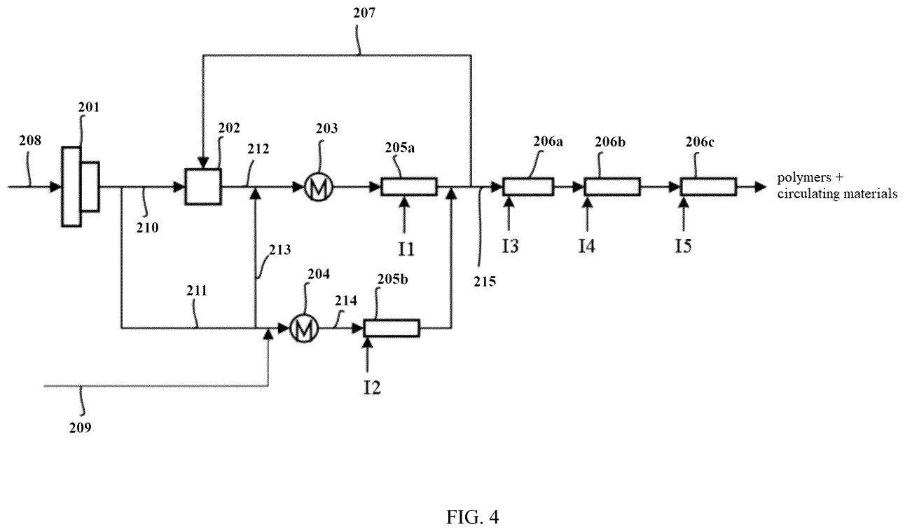

According to the method of the present invention, in other embodiments, the operation process of the method of the present invention is explained with reference to FIG. 4:
A strand of material C 208 which is fresh ethylene is compressed through the compression unit 201 and divided into two streams of reaction monomers containing ethylene source, respectively namely reaction monomer stream containing ethylene source A210 and reaction monomer stream containing ethylene source B211;
The reaction monomer stream containing ethylene source A210 is passed through the fluid suction and delivery apparatus 202 to obtain the reactive monomer stream containing ethylene source C212. The reaction monomer stream containing ethylene source C212 is mixed with the reaction monomer stream containing ethylene source D213 which is part of the reaction monomer stream containing ethylene source B211, and then preheated by the preheating apparatus 203 and introduced into the tubular reactor A in the one-stage high-pressure polymerization unit for reaction;
A strand of chain transfer agent 209 is supplied to the corresponding reaction monomer stream inlet end of the preheating apparatus B204 in the preheating unit through an outlet of the chain transfer agent supplying unit, and is mixed with the remaining portion of the reaction monomer stream containing ethylene source B211. After preheated by the preheating apparatus B204, the reaction monomer stream containing ethylene source E214 is obtained, and enters into the tubular reactor B in the one-stage high-pressure polymerization unit for reaction;
After the materials flowing out from the tubular reactor 205a and the tubular reactor 205b are collected, they are divided into two streams of materials, namely material A207 and material B215 respectively;
Material A207 is recycled back to the fluid suction and delivery apparatus 202 and mixed with the reaction monomer stream containing ethylene source A210 that flows into the fluid suction and delivery apparatus 202. After flowing out, it continues to be mixed with the reaction monomer stream containing ethylene source D213 which is part of the reaction monomer stream containing ethylene source B211, and then preheated by the preheating apparatus A203 and introduced into the tubular reactor 205a in the one-stage high-pressure polymerization unit for reaction;
Material B215 flows into the tubular reactor in the multi-stage high-pressure polymerization unit for reaction;
After reaction, the materials flowing out from the multi-stage high-pressure polymerization unit are separated through the separation and circulation unit to obtain polymer and circulating materials, and the circulating materials are returned to the inlet end of the compression unit 201;
Among them, the first initiator I1 and the second initiator I2 enter the corresponding first reaction zone 205a and the second reaction zone 205b through the first and second outlets of the initiator supply unit respectively to participate in the reaction in the one-stage high-pressure polymerization unit; the third initiator I3, the fourth initiator I4, and the fifth initiator I5 enter the corresponding third reaction zone 206a, the fourth reaction zone 206b and the fifth reaction zone 206c through the third, fourth, and fifth outlet of the initiator supply unit respectively to participate in the reaction in the multi-stage high-pressure polymerization unit.

In the present invention, the pressures involved are all absolute pressures.

The present invention will be described in detail below through examples. In the following examples, the number average molecular weight Mₙ, the weight average molecular weight M_{w}, and the polymer dispersion index PDI were all obtained through high temperature gel permeation chromatography (HT-GPC) according to the GB/T 36214.4-2018 standard.

### Example 201

Ethylene radical polymerization is carried out using an ethylene radical polymerization apparatus as shown in FIG. 3. In FIG. 3, the apparatus includes: polymerization unit, fluid suction and delivery unit, initiator supply unit, chain transfer agent supply unit, compression unit 201, preheating unit and separation and circulation unit.

The fluid suction and delivery unit includes a fluid suction and delivery apparatus 202 which is a jet pump for sucking and delivering at least a reaction monomer stream containing ethylene source and part of the material from the outlet of at least one tubular reactor in the one-stage high-pressure polymerization unit. The initiator supply unit is used to transport the initiator to the polymerization unit. The chain transfer agent supply unit is used to transport the chain transfer agent 209 to the apparatus. The compression unit 201 is used to enable that each reaction monomer stream has an inlet pressure for entering the one-stage high-pressure polymerization unit, and the compression unit 201 is located upstream of the fluid suction and delivery unit and the polymerization unit.

The polymerization unit includes a one-stage high-pressure polymerization unit and a multi-stage high-pressure polymerization unit connected in series downstream of the one-stage high-pressure polymerization unit. The one-stage high-pressure polymerization unit includes two parallel tubular reactors A and tubular reactor B. The lengths of tubular reactor A and tubular reactor B are both 560 m and the inner diameters are both 0.045 m. The inlet end of tubular reactor B is equipped with a pressure relief valve. In the multi-stage high-pressure polymerization unit, the apparatuses for reaction are three serial tubular reactors including tubular reactor C1, tubular reactor C2 and tubular reactor C3 connected in series. The lengths of tubular reactor C1, tubular reactor C2 and tubular reactor C3 are all 400 m and the inner diameters are all 0.045 m.

The one-stage high-pressure polymerization unit includes two reaction zones: the first and second outlets of the initiator supply unit are respectively connected with the reaction monomer stream containing ethylene source inlet ends of the tubular reactor A and tubular reactor B in the one-stage high-pressure polymerization unit to obtain the first reaction zone 205a and the second reaction zone 205b.

The multi-stage high-pressure polymerization unit includes three reaction zones connected in series: the third, fourth, and fifth outlet of the initiator supply unit are respectively connected with the inlet end of the tubular reactor C1 in the multi-stage high-pressure polymerization unit (referring to the inlet of the product from the one-stage high-pressure polymerization unit), the inlet end of the tubular reactor C2 (referring to the inlet of the product from the tubular reactor C1), the inlet end of the tubular reactor C3 (referring to the inlet of the product from the tubular reactor C2) to obtain the third reaction zone 206a, the fourth reaction zone 206b, and the fifth reaction zone 206c.

The fluid suction and delivery apparatus 202 is arranged in series upstream of the tubular reactor A in the one-stage high-pressure polymerization unit. The preheating unit includes two parallel preheating apparatuses, namely preheating apparatus A203 and preheating apparatus A204. Preheating apparatus A203 is located between the fluid suction and delivery apparatus 202 and the corresponding tubular reactor A in the one-stage high-pressure polymerization unit, Preheating apparatus A204 is located between the compression unit 201 and the corresponding tubular reactor B in the one-stage high-pressure polymerization unit.

An outlet of the chain transfer agent supply unit is connected to the outlet of the compression unit 201 for transporting the chain transfer agent into the apparatus.

The separation and circulation unit is located downstream of the polymerization unit to separate polymer products and recycling materials (unreacted monomers).

One strand of chain transfer agent 209 (propylene, the flow rate is 0.205 t/h) is introduced into the inlet of the compression unit 201 through an outlet of the chain transfer agent supply unit, mixed with one strand of material C208 (fresh ethylene, the flow rate is 43.5 t/h), compressed and then divided into two reaction monomer stream containing ethylene source, respectively namely the reaction monomer stream containing ethylene source A210 (the flow rate is 16.1 t/h) and the reaction monomer stream containing ethylene source B 211.

The reaction monomer stream containing ethylene source A210 is passed through the fluid suction and delivery apparatus 202 (the pressure drop is 28 MPa) to obtain the reaction monomer stream containing ethylene source C212. The reaction monomer stream containing ethylene source C212 is mixed with the reaction monomer stream containing ethylene source D213 which is part of the reaction monomer stream containing ethylene source B211 (the flow rate of the mixed reaction monomer stream is 26.72 t/h), and then preheated by the preheating apparatus A3 and introduced into the tubular reactor A in the one-stage high-pressure polymerization unit for reaction.

The remaining part of the reaction monomer stream containing ethylene source B211 is preheated by the preheating apparatus B204 to obtain the reaction monomer stream containing ethylene source E214. The reaction monomer stream containing ethylene source E214 passes through the pressure relief valve at the inlet side of tubular reactor B. After reducing the pressure to the required inlet pressure of the tubular reactor B, the reaction monomer stream containing ethylene source E214 enters the tubular reactor B in the one-stage high-pressure polymerization unit for reaction.

After the materials flowing out from the tubular reactor A and the tubular reactor B are collected, they are divided into two streams of materials, namely material A207 and material B215 respectively.

Material A207 is recycled back to the fluid suction and delivery apparatus 202 (circulation ratio is 0.10) and mixed with the reaction monomer stream containing ethylene source A210 that flows into the fluid suction and delivery apparatus 202. After flowing out, it continues to be mixed with the reaction monomer stream containing ethylene source D213 which is part of the reaction monomer stream containing ethylene source B211 and then preheated by the preheating apparatus A203 and introduced into the tubular reactor A in the one-stage high-pressure polymerization unit for reaction.

Material B215 flows into the tubular reactor in the multi-stage high-pressure polymerization unit for reaction.

Among them, the first initiator and the second initiator enter the first reaction zone 205a and the second reaction zone 205b respectively and correspondingly through the first and second outlets of the initiator supply unit to participate in the reaction in the one-stage high-pressure polymerization unit; the third, fourth, and fifth initiators enter the third reaction zone 206a, the fourth reaction zone 206b, and the fifth reaction zone 206c respectively and correspondingly through the third, fourth, and fifth outlet of the initiator supply unit to participate in the reaction in the multi-stage high-pressure polymerization unit.

Wherein:
The inlet pressures of tubular reactor A and tubular reactor B are both 220 MPa;
The flow rates of the first initiator, the second initiator, the third initiator, the fourth initiator and the fifth initiator are 6.72 kg/h, 6.80 kg/h, 8.34 kg/h, 7.44 kg/h, and 7.48 kg/h respectively.

The compositions of the first initiator and the second initiator are: a mixture of di-tert-butyl peroxide, tert-butyl peroxybenzoate, tert-butyl peroxy-2-ethylhexanoate and tert-butyl peroxypivalate mixed in a mass ratio of 1:2:2:2.

The compositions of the third initiator, the fourth initiator and the fifth initiator are: a mixture of di-tert-butyl peroxide, tert-butyl peroxybenzoate, tert-butyl peroxy-2-ethylhexanoate and tert-butyl peroxypivalate mixed in a mass ratio of 10:2:1:1.

The inlet temperature of the first reaction zone 205a is 170° C. and the outlet temperature is 194° C.; the inlet temperature of the second reaction zone 205b is 170° C. and the outlet temperature is 192° C. The inlet temperatures of the third reaction zone 206a, the fourth reaction zone 206b, and the fifth reaction zone 206c are 193° C., 211° C., and 229° C. respectively, and the outlet temperature of the fifth reaction zone 206c is 233° C. The peak temperatures of the first reaction zone 205a, the second reaction zone 205b, the third reaction zone 206a, the fourth reaction zone 206b and the fifth reaction zone 206c are all 295° C.

After reaction, the materials flowing out from the multi-stage high-pressure polymerization unit are separated through the separation and circulation unit to obtain polymer and circulating materials, and the circulating materials are returned to the inlet end of the compression unit 201.

After reaction, the materials flowing out from the multi-stage high-pressure polymerization unit are separated into polymer products (low-density polyethylene) and unreacted monomers (i.e. circulating materials) through the separation and circulation unit.

The number average molecular weight Mₙ, the weight average molecular weight M_{w}, the PDI, the yield and the ethylene conversion rate of LDPE are shown in the Table 2.

### Example 202

According to the method of Example 201, the differences are:

The method is carried out in an ethylene free radical polymerization apparatus as shown in FIG. 4.

An outlet of the chain transfer agent supply unit is connected to the reaction monomer stream inlet side of the tubular reactor B for transporting the chain transfer agent 209 into the apparatus.

A strand of material C208 (fresh ethylene, the flow rate is 43.5 t/h) is compressed by the compression unit 201 and divided into two reaction monomer streams containing ethylene source, respectively namely the reaction monomer stream containing ethylene source A210 and the reaction monomer stream containing ethylene source B211;

The reaction monomer stream containing ethylene source A210 is passed through the fluid suction and delivery apparatus 202 (the pressure drop is 28 MPa) to obtain the reaction monomer stream containing ethylene source C212. The reaction monomer stream containing ethylene source C212 is mixed with the reaction monomer stream containing ethylene source D213 which is part of the reaction monomer stream containing ethylene source B211 (the flow rate of the mixed reaction monomer stream is 26.72 t/h), and then preheated by the preheating apparatus 203 and introduced into the tubular reactor A in the one-stage high-pressure polymerization unit for reaction.

A strand of chain transfer agent 209 (propylene, the flow rate is 0.205 t/h) is introduced into the corresponding reaction monomer stream inlet end of the preheating apparatus 204 in the preheating unit through an outlet of the chain transfer agent supply unit, is mixed with the remaining portion in the reaction monomer stream containing ethylene source B211, and is preheated by the preheating equipment 204 to obtain the reaction monomer stream containing ethylene source E214. The reaction monomer stream containing ethylene source E214 passes through the pressure relief valve at the inlet end of the tubular reactor B. After reducing the pressure to the required inlet pressure of the tubular reactor B, the reaction monomer stream containing ethylene source E214 enters the tubular reactor B in the one-stage high-pressure polymerization unit for reaction.

Among them, the first initiator and the second initiator enter the first reaction zone 205a and the second reaction zone 205b respectively and correspondingly through the first and second outlets of the initiator supply unit to participate in the reaction in the one-stage high-pressure polymerization unit; the third, fourth, and fifth initiators enter the third reaction zone 206a, the fourth reaction zone 206b, and the fifth reaction zone 206c respectively and correspondingly through the third, fourth, and fifth outlet of the initiator supply unit to participate in the reaction in the multi-stage high-pressure polymerization unit.

Wherein:

The flow rates of the first initiator, the second initiator, the third initiator, the fourth initiator and the fifth initiator are 6.54 kg/h, 6.29 kg/h, 8.26 kg/h, 7.67 kg/h and 8.01 kg/h respectively.

The inlet temperature of the first reaction zone 205a is 170° C. and the outlet temperature is 193° C.; the inlet temperature of the second reaction zone 205b is 190° C. and the outlet temperature is 192° C. The inlet temperatures of the third reaction zone 206a, the fourth reaction zone 206b, and the fifth reaction zone 206c are 193° C., 211° C., and 225° C. respectively, and the outlet temperature of the fifth reaction zone 206c is 234° C.

The number average molecular weight Mₙ, the weight average molecular weight M_{w}, the PDI, the yield and the ethylene conversion rate of LDPE are shown in the Table 2.

### Example 203

According to the method of Example 201, the differences are:

An outlet of the chain transfer agent supply unit is not connected to the outlet of the compression unit 201, but is connected to the inlet of the multi-stage high-pressure polymerization unit (i.e., the inlet of the tubular reactor C1) for transporting the chain transfer agent 210 into the apparatus.

A strand of material C208 (fresh ethylene, the flow rate is 43.5 t/h) is compressed by the compression unit 201 and divided into two reaction monomer streams containing ethylene source, respectively namely the reaction monomer stream containing ethylene source A210 (the flow rate is 21 t/h) and the reaction monomer stream containing ethylene source B211.

The reaction monomer stream containing ethylene source A210 is passed through the fluid suction and delivery apparatus 202 (the pressure drop is 30 MPa) to obtain the reaction monomer stream containing ethylene source C212. The reaction monomer stream containing ethylene source C212 is mixed with the reaction monomer stream containing ethylene source D213 which is part of the reaction monomer stream containing ethylene source B211 (the flow rate of the mixed reaction monomer stream is 26.72 t/h), and then preheated by the preheating apparatus A3 and introduced into the tubular reactor A in the one-stage high-pressure polymerization unit for reaction.

The remaining part of the reaction monomer stream containing ethylene source B211 is preheated by the preheating apparatus B204 to obtain the reaction monomer stream containing ethylene source E214. The reaction monomer stream containing ethylene source E214 passes through the pressure relief valve at the inlet side of tubular reactor B. After reducing the pressure to the required inlet pressure of the tubular reactor B, the reaction monomer stream containing ethylene source E214 enters the tubular reactor B in the one-stage high-pressure polymerization unit for reaction.

Material A207 is recycled back to the fluid suction and delivery apparatus 202 (circulation ratio is 0.15) and mixed with the reaction monomer stream containing ethylene source A210 that flows into the fluid suction and delivery apparatus 202. After flowing out, it continues to be mixed with the reaction monomer stream containing ethylene source D213 which is part of the reaction monomer stream containing ethylene source B211 and then preheated by the preheating apparatus A203 and introduced into the tubular reactor A in the one-stage high-pressure polymerization unit for reaction.

After the materials flowing out from the tubular reactor A and the tubular reactor B are collected, they are divided into two streams of materials, namely material A207 and material B215 respectively.

A strand of chain transfer agent 209 (propylene, the flow rate is 0.205 t/h) is introduced into the inlet of the multi-stage high-pressure polymerization unit through an outlet of the chain transfer agent supply unit, is mixed with material B, and then flows into the tubular reactor in the multi-stage high-pressure polymerization unit for reaction.

Wherein:

The flow rates of the first initiator, the second initiator, the third initiator, the fourth initiator and the fifth initiator are 6.48 kg/h, 6.11 kg/h, 8.84 kg/h, 7.79 kg/h, and 8.11 kg/h respectively.

The inlet temperature of the first reaction zone 205a is 170° C. and the outlet temperature is 196° C.; the inlet temperature of the second reaction zone 205b is 185° C. and the outlet temperature is 192° C. The inlet temperatures of the third reaction zone 206a, the fourth reaction zone 206b, and the fifth reaction zone 206c are 194° C., 210° C., and 225° C. respectively, and the outlet temperature of the fifth reaction zone 206c is 234° C.

The number average molecular weight Mₙ, the weight average molecular weight M_{w}, the PDI, the yield and the ethylene conversion rate of LDPE are shown in the Table 2.

### Example 204

According to the method of Example 201, the differences are:

The inlet pressures of tubular reactor A and tubular reactor B are both 270 MPa.

The flow rates of the first initiator, the second initiator, the third initiator, the fourth initiator and the fifth initiator are 3.76 kg/h, 3.79 kg/h, 4.66 kg/h, 4.22 kg/h, 4.27 kg/h respectively.

The inlet temperature of the first reaction zone 205a is 170° C. and the outlet temperature is 194° C.; the inlet temperature of the second reaction zone 205b is 170° C. and the outlet temperature is 192° C. The inlet temperatures of the third reaction zone 206a, the fourth reaction zone 206b, and the fifth reaction zone 206c are 193° C., 209° C., and 229° C. respectively, and the outlet temperature of the fifth reaction zone 206c is 233° C.

The number average molecular weight Mₙ, the weight average molecular weight M_{w}, the PDI, the yield and the ethylene conversion rate of LDPE are shown in the Table 2.

### Example 205

According to the method of Example 201, the differences are:

The flow rates of the first initiator, the second initiator, the third initiator, the fourth initiator and the fifth initiator are 7.89 kg/h, 7.95 kg/h, 9.77 kg/h, 8.97 kg/h, 9.41 kg/h respectively.

The inlet temperature of the first reaction zone 205a is 170° C. and the outlet temperature is 194° C.; the inlet temperature of the second reaction zone 205b is 170° C. and the outlet temperature is 192° C. The inlet temperatures of the third reaction zone 206a, the fourth reaction zone 206b, and the fifth reaction zone 206c are 193° C., 210° C., and 229° C. respectively, and the outlet temperature of the fifth reaction zone 206c is 235° C. The peak temperatures of the first reaction zone 205a, the second reaction zone 205b, the third reaction zone 206a, the fourth reaction zone 206b and the fifth reaction zone 206c are all 300° C.

The number average molecular weight Mₙ, the weight average molecular weight M_{w}, the PDI, the yield and the ethylene conversion rate of LDPE are shown in the Table 2.

### Example 206

According to the method of Example 201, the differences are:

The apparatus used for reaction in the multi-stage high-pressure polymerization unit is a tubular reactor C. The length of the tubular reactor C is 1200 m and the inner diameter is 0.045 m. The one-stage high-pressure polymerization unit includes two reaction zones: the first and second outlets of the initiator supply unit are respectively connected with the reaction monomer stream containing ethylene source inlet ends of the tubular reactor A and tubular reactor B in the one-stage high-pressure polymerization unit to obtain the first reaction zone 205a and the second reaction zone 205b.

The multi-stage high-pressure polymerization unit includes two reaction zones connected in series: the third outlet of the initiator supply unit is connected with the inlet end of the multi-stage high-pressure polymerization unit (referring to the port that the product from the one-stage high-pressure polymerization unit flows into) to obtain the third reaction zone 206a; the fourth outlet of the initiator supply unit is connected to a position 400 m away along the material flow direction from the inlet end of the multi-stage high-pressure polymerization unit to obtain the fourth reaction zone 206b.

The first initiator and the second initiator enter the first reaction zone 205a and the second reaction zone 205b respectively and correspondingly through the first and second outlets of the initiator supply unit to participate in the reaction in the one-stage high-pressure polymerization unit; the third, and fourth initiators enter the third reaction zone 206a, and the fourth reaction zone 206b respectively and correspondingly through the third, and fourth outlet of the initiator supply unit to participate in the reaction in the multi-stage high-pressure polymerization unit.

The flow rates of the first initiator, the second initiator, the third initiator and the fourth initiator are 6.75 kg/h, 6.81 kg/h, 8.33 kg/h and 7.46 kg/h respectively.

The inlet temperature of the first reaction zone 205a is 170° C. and the outlet temperature is 194° C.; the inlet temperature of the second reaction zone 205b is 170° C. and the outlet temperature is 192° C. The inlet temperatures of the third reaction zone 206a and the fourth reaction zone 206b are 193° C. and 211° C. respectively, and the outlet temperature of the fourth reaction zone 206b is 230° C.

The number average molecular weight Mₙ, the weight average molecular weight M_{w}, the PDI, the yield and the ethylene conversion rate of LDPE are shown in the Table 2.

### Example 207

According to the method of Example 201, the differences are:

Material A207 is recycled back to the fluid suction and delivery apparatus 202 (circulation ratio is 0.03) and mixed with the reaction monomer stream containing ethylene source A210 that flows into the fluid suction and delivery apparatus 202. After flowing out, it continues to be mixed with the reaction monomer stream containing ethylene source D213 which is part of the reaction monomer stream containing ethylene source B211 and then preheated by the preheating apparatus A203 and introduced into the tubular reactor A in the one-stage high-pressure polymerization unit for reaction.

After the materials flowing out from the tubular reactor A and the tubular reactor B are collected, they are divided into two streams of materials, namely material A207 and material B215 respectively.

Wherein:

The flow rates of the first initiator, the second initiator, the third initiator, the fourth initiator and the fifth initiator are 6.83 kg/h, 6.80 kg/h, 7.68 kg/h, 7.35 kg/h, and 7.43 kg/h respectively.

The inlet temperature of the first reaction zone 205a is 170° C. and the outlet temperature is 193° C.; the inlet temperature of the second reaction zone 205b is 170° C. and the outlet temperature is 192° C. The inlet temperatures of the third reaction zone 206a, the fourth reaction zone 206b, and the fifth reaction zone 206c are 192° C., 211° C., and 229° C. respectively, and the outlet temperature of the fifth reaction zone 206c is 233° C.

The number average molecular weight Mₙ, the weight average molecular weight M_{w}, the PDI, the yield and the ethylene conversion rate of LDPE are shown in the Table 2.

### Comparative Example 201

According to the method of Example 201, the differences are:

There is no fluid suction and delivery unit in the ethylene free radical polymerization apparatus. The one-stage high-pressure polymerization unit includes a tubular reactor A. The length of the tubular reactor A is 560 m and the inner diameter is 0.045 m. The preheating unit includes the preheating apparatus A203. The preheating equipment A203 is located between the compression unit 201 and the corresponding tubular reactor A in the one-stage high-pressure polymerization unit.

The one-stage high-pressure polymerization unit includes a reaction zone: the first outlet of the initiator supply unit is connected to the reaction monomer stream containing the ethylene source inlet end of the tubular reactor A in the one-stage high-pressure polymerization unit to obtain the first reaction zone 205a.

The multi-stage high-pressure polymerization unit includes three reaction zones connected in series: the second, third, and fourth outlet of the initiator supply unit are respectively connected with the inlet end of the tubular reactor C1 in the multi-stage high-pressure polymerization unit (referring to the inlet of the product from the one-stage high-pressure polymerization unit), the inlet end of the tubular reactor C2 (referring to the inlet of the product from the tubular reactor C1), the inlet end of the tubular reactor C3 (referring to the inlet of the product from the tubular reactor C2) to obtain the second reaction zone 206a, the third reaction zone 206b, and the fourth reaction zone 206c.

Among them, a strand of chain transfer agent 209 (propylene, the flow rate is 0.205 t/h) is introduced into the inlet of the compression unit 201 through an outlet of the chain transfer agent supply unit mixed with a strand of material C208 (fresh ethylene, the flow rate is 43.5 t/h) compressed and then passing through preheating apparatus A203. After preheating, it is sent to the tubular reactor A for reaction, and the material flowing out from the tubular reaction A flows into the tubular reactor in the multi-stage high-pressure polymerization unit for reaction.

Among them, the first initiator enters the corresponding first reaction zone 205a through the first outlet of the initiator supply unit to participate in the reaction in the one-stage high-pressure polymerization unit; the second, third, and fourth initiators enter the second reaction zone 206a, the third reaction zone 206b and the fourth reaction zone 206c respectively and correspondingly through the third, fourth, and fifth outlet of the initiator supply unit to participate in the reaction in the multi-stage high-pressure polymerization unit.

Wherein:
The inlet pressure of tubular reactor A is 220 MPa;
The flow rates of the first initiator, the second initiator, the third initiator and the fourth initiator are 14.66 kg/h, 7.42 kg/h, 7.36 kg/h and 7.36 kg/h respectively;
The inlet temperature of the first reaction zone 205a is 170° C. and the outlet temperature is 194° C. The inlet temperatures of the second reaction zone 206a, the third reaction zone 206b, and the fourth reaction zone 206c are 194° C., 210° C., and 229° C. respectively, and the outlet temperature of the fourth reaction zone 206c is 233° C.

The number average molecular weight Mₙ, the weight average molecular weight M_{w}, the PDI, the yield and the ethylene conversion rate of LDPE are shown in the Table 2.

### Comparative Example 202

According to the method of Example 201, the differences are:

The circulation ratio is 0.

The flow rates of the first initiator, the second initiator, the third initiator, the fourth and the fifth initiator are 6.80 kg/h, 6.80 kg/h, 7.42 kg/h, 7.26 kg/h and 7.36 kg/h respectively.

The inlet temperature of the first reaction zone 205a and the second reaction zone 205b are both 170° C. and the outlet temperature is 192° C. The inlet temperatures of the third reaction zone 206a, the fourth reaction zone 206b, and the fifth reaction zone 206c are 192° C., 211° C., and 229° C. respectively, and the outlet temperature of the fifth reaction zone 206c is 233° C.

The number average molecular weight Mₙ, the weight average molecular weight M_{w}, the PDI, the yield and the ethylene conversion rate of LDPE are shown in the Table 2.

### Comparative Example 203

According to the method of Example 204, the differences are:

There is no fluid suction and delivery unit in the ethylene free radical polymerization apparatus. The one-stage high-pressure polymerization unit includes a tubular reactor A. The length of the tubular reactor A is 560 m and the inner diameter is 0.045 m. The preheating unit includes the preheating apparatus A203. The preheating equipment A203 is located between the compression unit 201 and the corresponding tubular reactor A in the one-stage high-pressure polymerization unit.

The one-stage high-pressure polymerization unit includes a reaction zone: the first outlet of the initiator supply unit is connected to the reaction monomer stream containing the ethylene source inlet end of the tubular reactor A in the one-stage high-pressure polymerization unit to obtain the first reaction zone 205a.

The multi-stage high-pressure polymerization unit includes three reaction zones connected in series: the second, third, and fourth outlet of the initiator supply unit are respectively connected with the inlet end of the tubular reactor C1 in the multi-stage high-pressure polymerization unit (referring to the inlet of the product from the one-stage high-pressure polymerization unit), the inlet end of the tubular reactor C2 (referring to the inlet of the product from the tubular reactor C1), the inlet end of the tubular reactor C3 (referring to the inlet of the product from the tubular reactor C2) to obtain the second reaction zone 206a, the third reaction zone 206b, and the fourth reaction zone 206c.

Among them, a strand of chain transfer agent 209 (propylene, the flow rate is 0.205 t/h) is introduced into the inlet of the compression unit 201 through an outlet of the chain transfer agent supply unit mixed with a strand of material C208 (fresh ethylene, the flow rate is 43.5 t/h) compressed and then passing through preheating apparatus A203. After preheating, it is sent to the tubular reactor A for reaction, and the material flowing out from the tubular reaction A flows into the tubular reactor in the multi-stage high-pressure polymerization unit for reaction.

Among them, the first initiator enters the corresponding first reaction zone 205a through the first outlet of the initiator supply unit to participate in the reaction in the one-stage high-pressure polymerization unit; the second, third, and fourth initiators enter the second reaction zone 206a, the third reaction zone 206b and the fourth reaction zone 206c respectively and correspondingly through the third, fourth, and fifth outlet of the initiator supply unit to participate in the reaction in the multi-stage high-pressure polymerization unit.

Wherein:
The inlet pressure of tubular reactor A is 270 MPa;
The flow rates of the first initiator, the second initiator, the third initiator and the fourth initiator are 8.12 kg/h, 4.14 kg/h, 4.12 kg/h, 4.18 kg/h respectively;
The inlet temperature of the first reaction zone 205a is 170° C. and the outlet temperature is 193° C. The inlet temperatures of the second reaction zone 206a, the third reaction zone 206b, and the fourth reaction zone 206c are 193° C., 210° C., and 229° C. respectively, and the outlet temperature of the fourth reaction zone 206c is 233° C.

The number average molecular weight Mₙ, the weight average molecular weight M_{w}, the PDI, the yield and the ethylene conversion rate of LDPE are shown in the Table 2.

### Comparative Example 204

According to the method of Example 205, the differences are:

There is no fluid suction and delivery unit in the ethylene free radical polymerization apparatus. The one-stage high-pressure polymerization unit includes a tubular reactor A. The length of the tubular reactor A is 560 m and the inner diameter is 0.045 m. The preheating unit includes the preheating apparatus A203. The preheating equipment A203 is located between the compression unit 201 and the corresponding tubular reactor A in the one-stage high-pressure polymerization unit.

The one-stage high-pressure polymerization unit includes a reaction zone: the first outlet of the initiator supply unit is connected to the reaction monomer stream containing the ethylene source inlet end of the tubular reactor A in the one-stage high-pressure polymerization unit to obtain the first reaction zone 205a.

The multi-stage high-pressure polymerization unit includes three reaction zones connected in series: the second, third, and fourth outlet of the initiator supply unit are respectively connected with the inlet end of the tubular reactor C1 in the multi-stage high-pressure polymerization unit (referring to the inlet of the product from the one-stage high-pressure polymerization unit), the inlet end of the tubular reactor C2 (referring to the inlet of the product from the tubular reactor C1), the inlet end of the tubular reactor C3 (referring to the inlet of the product from the tubular reactor C2) to obtain the second reaction zone 206a, the third reaction zone 206b, and the fourth reaction zone 206c.

Among them, a strand of chain transfer agent 209 (propylene, the flow rate is 0.205 t/h) is introduced into the inlet of the compression unit 201 through an outlet of the chain transfer agent supply unit mixed with a strand of material C208 (fresh ethylene, the flow rate is 43.5 t/h) compressed and then passing through preheating apparatus A203. After preheating, it is sent to the tubular reactor A for reaction, and the material flowing out from the tubular reaction A flows into the tubular reactor in the multi-stage high-pressure polymerization unit for reaction.

Among them, the first initiator enters the corresponding first reaction zone 205a through the first outlet of the initiator supply unit to participate in the reaction in the one-stage high-pressure polymerization unit; the second, third, and fourth initiators enter the second reaction zone 206a, the third reaction zone 206b and the fourth reaction zone 206c respectively and correspondingly through the third, fourth, and fifth outlet of the initiator supply unit to participate in the reaction in the multi-stage high-pressure polymerization unit.

Wherein:
The inlet pressures of tubular reactor A is 220 MPa;
The flow rates of the first initiator, the second initiator, the third initiator and the fourth initiator are 16.85 kg/h, 8.65 kg/h, 8.76 kg/h and 9.15 kg/h respectively;
The inlet temperature of the first reaction zone 205a is 170° C. and the outlet temperature is 193° C. The inlet temperatures of the second reaction zone 206a, the third reaction zone 206b, and the fourth reaction zone 206c are 193° C., 211° C., and 230° C. respectively, and the outlet temperature of the fourth reaction zone 206c is 235° C.

The number average molecular weight Mₙ, the weight average molecular weight M_{w}, the PDI, the yield and the ethylene conversion rate of LDPE are shown in the Table 2.

### Comparative Example 205

According to the method of Example 206, the differences are:

The circulation ratio is 0.

The flow rates of the first initiator, the second initiator, the third initiator and the fourth initiator are 6.79 kg/h, 6.80 kg/h, 7.43 kg/h and 7.26 kg/h respectively.

The inlet temperature of the first reaction zone 205a is 170° C. and the outlet temperature is 192° C. The inlet temperature of the second reaction zone 205b is 170° C. and the outlet temperature is 192° C. The inlet temperatures of the third reaction zone 206a, and the fourth reaction zone 206b are 192° C. and 211° C. respectively, and the outlet temperature of the fourth reaction zone 206b is 229° C.

The number average molecular weight Mₙ, the weight average molecular weight M_{w}, the PDI, the yield and the ethylene conversion rate of LDPE are shown in the Table 2.

TABLE 2

| | | | | | Conver- | Conver- |
|---|---|---|---|---|---|---|
| | | | | | sion | sion |
| | Mₙ | M_{w} | | Yield | rate | rate/ |
| Number | [g/mol] | _{[}g/mol] | PDI | [kg/h] | [%] | PDI |
| Example 201 | 15000 | 111846 | 7.46 | 15762 | 36.2 | 0.049 |
| Example 202 | 15026 | 139964 | 9.31 | 15802 | 36.3 | 0.039 |
| Example 203 | 15009 | 202931 | 13.52 | 16069 | 36.9 | 0.027 |
| Example 204 | 19594 | 145770 | 7.90 | 15696 | 36.1 | 0.046 |
| Example 205 | 14553 | 116644 | 8.01 | 16318 | 37.5 | 0.047 |
| Example 206 | 16145 | 105847 | 6.56 | 13168 | 30.3 | 0.046 |
| Example 207 | 1 5050 | 1 06278 | 7.06_{—} | 1 5519 | 3 5.6 | 0.050_{—} |
| Comparative | 15013 | 101626 | 6.76 | 15452 | 35.5 | 0.053 |
| Example 201 | | | | | | |
| Comparative | 15040 | 100868 | 6.70 | 15332 | 35.3 | 0.053 |
| Example 202 | | | | | | |
| Comparative | 19578 | 135200 | 6.91 | 15277 | 35.1 | 0.051 |
| Example 203 | | | | | | |
| Comparative | 14546 | 100505 | 6.91 | 15854 | 36.4 | 0.053 |
| Example 204 | | | | | | |
| Comparative | 16156 | 90878 | 5.62 | 12606 | 29.0 | 0.052 |
| Example 205 | | | | | | |

Through the comparison between Examples 201-205 and 207 and Comparative Examples 201-204, which the multi-stage high-pressure polymerization of the present invention includes three serial reaction zones, and the comparison between Examples 206 and Comparative Examples 205, which the multi-stage high-pressure polymerization of the present invention includes two serial reaction zones, it can be seen from the results in Table 2 that when the molecular weight distribution index of the product is adjusted through parameters such as the feeding position of the chain transfer agent, the reaction temperature, and the feeding amount of the initiator, the apparatuses in Examples 201-207 of the present invention can better achieve the control effect of a wider range of molecular weight distribution index, and can also obtain products with a wider molecular weight distribution index and higher conversion rates.

The preferred embodiments of the present invention have been described in detail above, but the present invention is not limited thereto. Within the scope of the technical concept of the present invention, various simple modifications can be made to the technical solution of the present invention, including the combination of various technical features in any other suitable manner.

These simple modifications and combinations should also be regarded as the disclosed content of the present invention and all belong to the protection scope of the present invention.

1-25. (canceled)

26. A method for olefin free radical polymerization, wherein the method includes:
introducing reaction monomer stream containing olefin source into at least two parallel tubular reactors, performing one-stage high-pressure polymerization respectively, and then introducing the obtained one-stage high-pressure polymerization product into one or more serial tubular reactors to perform multi-stage high-pressure polymerization;
Wherein, at least one strand of free radical polymerization initiator is introduced to participate in one-stage high-pressure polymerization and/or multi-stage high-pressure polymerization respectively and the pressure of the reaction monomer stream containing olefin source is greater than or equal to 100 MPa.

27. The method according to claim 26, wherein the pressure of the reaction monomer stream containing olefin source is 110-400 MPa;
and/or, the ratio of the sum of the pressure drop before and after one-stage high-pressure polymerization and the pressure drop before and after multi-stage high-pressure polymerization to the pressure drop before and after one-stage high-pressure polymerization is 3:1-30:1.

28. The method according to claim 26, wherein the temperature of each strand of the reaction monomer streams containing olefin source is 100-200° C. respectively, and the sum of the reaction monomer streams containing olefin source at the inlet of each parallel tubular reactor respectively satisfies the correlation expression: 10000≥ρ₁/μ₁≥1500, the unit of density ρ₁ is kg/m³, and the unit of viscosity μ₁ is cP;
and/or, the temperature of each one-stage high-pressure polymerization and each multi-stage high-pressure polymerization are 100-350° C. respectively;
and/or, the ratio of the maximum feed amount to the minimum feed amount of each reaction monomer stream containing olefin source is (20-1):1;
and/or, the flow rate of each strand of the reaction monomer streams containing olefin source is respectively greater than or equal to 5 m/s, and less than or equal to 30 m/s;
and/or, the number of tubular reactors for the one-stage high-pressure polymerization is 2-4;
and/or, at least one strand of free radical initiator is introduced to participate in the one-stage high-pressure polymerization; at least one strand of initiator is introduced to participate in the multi-stage high-pressure polymerization.

29. The method according to claim 26, wherein the method comprises feeding at least one strand of telogen respectively to participate in the one-stage high-pressure polymerization and/or multi-stage high-pressure polymerization;
and/or, the method further includes feeding at least one strand of comonomer respectively to participate in the one-stage high-pressure polymerization and/or the multi-stage high-pressure polymerization;
and/or, the method further includes: cooling the material obtained by the multi-stage high-pressure polymerization under reduced pressure, and then separating it to obtain the unreacted monomer and the polymer products.

30. The method according to claim 29, wherein the telogen includes one or more of aliphatic hydrocarbons, olefins, ketones, aldehydes, aliphatic alcohols and hydrogen.

31. The method according to claim 26, wherein the olefins in the olefin source include one or more of R₂C═CR₂ type monoolefins, conjugated diolefins, and non-conjugated diolefins, wherein each R is selected from H, hydrocarbyl or halogen respectively;
and/or, the free radical polymerization initiator includes one or more of oxygen, air, azo compounds, organic peroxides and hydrocarbons of C—C initiators.

32. The method according to claim 26, wherein the method comprises: introducing a reaction monomer stream containing ethylene source into at least two parallel tubular reactors to react in the presence of an initiator; part of the material from the outlet of at least one of the at least two parallel tubular reactors is recycled back to at least one of the at least two parallel tubular reactors for reaction; the remaining material from the outlet of the reactor is continuously introduced into one or more serial tubular reactors to react in the presence of an initiator.

33. The method according to claim 32, wherein the circulation ratio of the material at the outlets of the at least two parallel tubular reactors is less than 1;
and/or, the pressure of the reaction monomer stream containing ethylene source flowing into at least two parallel tubular reactors is 140-300 MPa;
and/or, the reaction temperatures in the at least two parallel tubular reactors and one or more serial tubular reactors are 100-350° C. respectively;
and/or, the weight ratio of the maximum feed amount and the minimum feed amount of the reaction monomer stream in the at least two parallel tubular reactors is 1:(0.01-1);
and/or, the initiator is introduced into at least two parallel tubular reactors and one or more serially connected tubular reactors.

34. The method according to claim 33, wherein the method further comprises introducing a chain transfer agent into the at least two parallel tubular reactors and one or more serial tubular reactors;
and/or, the method further includes introducing at least one strand of comonomer into at least two parallel tubular reactors, and one or more serial tubular reactors.

35. The method according to claim 34, wherein the chain transfer agent is selected from one or more of aliphatic hydrocarbons, olefins, ketones, aldehydes, aliphatic alcohols and hydrogen; the initiator is selected from one or more of azo compounds, organic peroxides, oxygen and air.

36. An olefin radical polymerization apparatus, wherein the apparatus includes: a one-stage high-pressure polymerization unit and a multi-stage high-pressure polymerization unit; wherein the one-stage high-pressure polymerization unit is connected in series upstream of the multi-stage high-pressure polymerization unit; the one-stage high-pressure polymerization unit includes at least two parallel tubular reactors for conducting one-stage high-pressure polymerization on at least two reaction monomer streams containing olefin source respectively;
the multi-stage high-pressure polymerization unit includes one or more serial tubular reactors for multi-stage high-pressure polymerization of the product from the one-stage high-pressure polymerization unit;
at least one tubular reactor in the one-stage high-pressure polymerization unit and/or the multi-stage high-pressure polymerization unit is provided with an initiator inlet.

37. The apparatus according to claim 36, wherein the one-stage high-pressure polymerization unit includes 2-4 parallel tubular reactors;
and/or, the reaction monomer stream inlet end of at least one tubular reactor in the one-stage high-pressure polymerization unit is provided with an initiator inlet;
and/or, at least one tubular reactor in the one-stage high-pressure polymerization unit is provided with at least one initiator inlet along its length direction;
and/or, at least one tubular reactor in the multi-stage high-pressure polymerization unit is provided with at least one initiator inlet.

38. The apparatus according to claim 36, wherein the apparatus further comprises at least one compression unit located upstream of the one-stage high-pressure polymerization unit, for providing each strand of reaction monomer stream containing olefin source with an inlet pressure for entering the one-stage high-pressure polymerization unit; wherein the compression unit includes one or more serial compressors;
the apparatus further includes at least one preheater located upstream of the one-stage high-pressure polymerization unit, for providing each of the reaction monomer streams containing olefin source with an inlet temperature for entering the one-stage high-pressure polymerization unit.

39. The apparatus according to claim 38, wherein at least one compression unit is arranged in series at the common upstream of at least two parallel tubular reactors in the one-stage high-pressure polymerization unit;
and/or, at least one compression unit is arranged in series respectively at the corresponding upstream of each tubular reactor in the one-stage high-pressure polymerization unit;
and/or, the preheater is located between the compression unit and the one-stage high-pressure polymerization unit;
and/or, at least one preheater is arranged in series at the common upstream of at least two parallel tubular reactors in the one-stage high-pressure polymerization unit;
and/or, at least one preheater is arranged in series respectively at the corresponding upstream of each tubular reactor in the one-stage high-pressure polymerization unit;
the apparatus further comprises at least one telogen inlet and/or at least one comonomer inlet;
and/or, the telogen inlet is provided at any position upstream of the outlet of the multi-stage high-pressure polymerization unit;
wherein, the comonomer inlet is provided at any position upstream of the outlet of the one-stage high-pressure polymerization unit.

40. The apparatus according to claim 39, wherein each of the telogen inlets is respectively arranged at: the inlet of the compression unit;
and/or, the outlet of the compression unit;
and/or, the connecting pipe between any two adjacent compressors in the compression unit;
and/or, the reaction monomer stream inlet end of at least one tubular reactor in the one-stage high-pressure polymerization unit;
and/or, at least one tubular reactor in the one-stage high-pressure polymerization unit;
and/or, the connecting pipe between the one-stage high-pressure polymerization unit and the multi-stage high-pressure polymerization unit;
and/or, at least one tubular reactor in the multi-stage high-pressure polymerization unit;
and/or, each of the comonomer inlets is respectively arranged at: the inlet of the compression unit;
and/or, the connecting pipe between any two adjacent compressors in the compression unit;
and/or, the reaction monomer stream inlet end of at least one tubular reactor in the one-stage high-pressure polymerization unit;
and/or, the connecting pipe between the preheater and the compression unit.

41. The apparatus according to claim 36, wherein the apparatus further comprises: fluid suction and delivery unit, wherein the fluid suction and delivery unit includes one or at least two parallel fluid suction and delivery apparatuses for suction and conveying at least one strand of reaction monomer stream containing ethylene source and part of the material from the outlet of at least one tubular reactor in the one-stage high-pressure polymerization unit;
the initiator supply unit is used to deliver initiators to the one-stage high-pressure polymerization unit and the multi-stage high-pressure polymerization unit.

42. The apparatus according to claim 41, wherein the one-stage high-pressure polymerization unit includes 2-4 parallel tubular reactors;
and/or, at least one fluid suction and delivery apparatuses is arranged in series at the common upstream of at least two parallel tubular reactors in the one-stage high-pressure polymerization unit;
and/or, at least one fluid suction and delivery apparatuses is arranged in series respectively at the corresponding upstream of each tubular reactor in the one-stage high-pressure polymerization unit;
and/or, the apparatus further comprises compression unit located upstream of the fluid suction and delivery unit and the polymerization unit, for providing the reaction monomer streams containing ethylene source with an inlet pressure for entering the one-stage high-pressure polymerization unit;
wherein the compression unit includes at least second-stage compressor;
and/or, the apparatus further includes preheating unit located upstream of the polymerization unit, for providing the reaction monomer streams containing ethylene source with a feed temperature for entering the polymerization unit, wherein the preheating unit includes one or more preheating apparatuses arranged in parallel.

43. The apparatus according to claim 42, wherein at least one compression unit is arranged in series at the common upstream of at least two parallel tubular reactors in the fluid suction and delivery unit;
and/or, at least one compression unit is arranged in series respectively at the corresponding upstream of each fluid suction and delivery apparatus in the fluid suction and delivery unit;
and/or, at least one preheating apparatus is arranged in series at the common upstream of at least two parallel tubular reactors in the one-stage high-pressure polymerization unit;
and/or, at least one preheating apparatus is arranged in series respectively at the corresponding upstream of each tubular reactor in the one-stage high-pressure polymerization unit;
and/or, at least one preheating apparatus is located between the compression unit and the corresponding tubular reactor in the one-stage high-pressure polymerization unit;
and/or, at least one preheating apparatus is located between the corresponding fluid suction apparatus in the fluid suction and delivery unit and the corresponding tubular reactor in the one-stage high-pressure polymerization unit.

44. The apparatus according to claim 42, wherein the apparatus further comprises: chain transfer agent supply unit for delivering the chain transfer agent into the apparatus;
wherein, at least one outlet of the chain transfer agent supply unit is connected to any position on the tubular reactor in the one-stage high-pressure polymerization unit;
and/or, at least one outlet of the chain transfer agent supply unit is connected to the respectively corresponding reaction monomer stream inlet end of the preheating apparatus;
and/or, at least one outlet of the chain transfer agent supply unit is connected to the common upstream of at least two parallel preheating apparatuses;
and/or, at least one outlet of the chain transfer agent supply unit is connected to the respectively corresponding reaction monomer stream inlet end of the fluid suction and delivery apparatus;
and/or, at least one outlet of the chain transfer agent supply unit is connected to the common upstream of at least two parallel fluid suction and delivery apparatuses;
and/or, at least one outlet of the chain transfer agent supply unit is connected to the inlet end of the multi-stage high-pressure polymerization unit;
and/or, at least one outlet of the chain transfer agent supply unit is connected to any position in the multi-stage high-pressure polymerization unit;
and/or, at least one outlet of the chain transfer agent supply unit is connected to the inlet of the compression unit;
and/or, at least one outlet of the chain transfer agent supply unit is connected to any position on the connection pipe in the compression interstage of the compression unit.

45. The apparatus according to claim 42, wherein the apparatus further comprises comonomer supply unit to provide comonomer into the apparatus; wherein at least one outlet of the comonomer supply unit is connected to the respectively corresponding reaction monomer stream inlet end of the tubular reactors in the one-stage high-pressure polymerization unit;
and/or, at least one outlet of the comonomer supply unit is connected to the respectively corresponding reaction monomer stream inlet end of the preheating apparatus;
and/or, at least one outlet of the comonomer supply unit is connected to the common upstream of at least parallel two preheating apparatuses;
and/or, at least one outlet of the comonomer supply unit is connected to the respectively corresponding reaction monomer stream inlet end of the fluid suction and delivery apparatus;
and/or, at least one outlet of the comonomer supply unit is connected to the common upstream of at least parallel two fluid suction and conveying apparatuses;
and/or, at least one outlet of the comonomer supply unit is connected to the inlet of the compression unit;
and/or, at least one outlet of the comonomer supply unit is connected to any position on the connection pipe in the compression interstage of the compression unit.
